(19) United States
(12) Patent Application Publication
(10) Pub. No.: US 2019/0068526 A1
(43) Pub. Date: Feb. 28, 2019

(54) METHODS AND SYSTEMS FOR HELPER BOT PLATFORM ASSISTANCE

(71) Applicant: Facebook, Inc., Menlo Park, CA (US)

(72) Inventors: Tianyu Xie, Jersey City, NJ (US); Andrew Buchanan Flockhart, New York, NY (US); Shi He, Belmont, CA (US); Atol Fortin de Oliveira, San Francisco, CA (US)

(21) Appl. No.: 15/686,240

(22) Filed: Aug. 25, 2017

(51) Int. Cl. H04L 12/58; H04L 29/08

(52) U.S. Cl. CPC H04L 51/02; H04L 67/22; H04L 51/32; G06Q 50/01; H04L 51/16; H04L 67/02; H04L 67/146

(57) ABSTRACT

Exemplary embodiments relate to methods, mediums, and systems for messaging bots configured to converse with page administrators and advertisers to assist them in managing their presence on a platform, such as a social networking service. A user may have a problem or be able to optimize their presence on the platform in some way, but may not know to search for the issue (or may not even know that they have a problem). Exemplary embodiments provide a helper bot that can be triggered by real-time or asynchronous events, and guide the user through problem-solving. Triggered messages to the users can be delayed or sent under certain conditions to prevent spamming the user. The messages have a custom format that allows the conversation to be represented as a chain encapsulating the entire conversation context.

### BACKGROUND

Various content providers, such as page administrators or advertisers, may interact with a platform (e.g., a social media platform) to make content available to the platform's user base. However, when developing content such as user interfaces for the platform, the providers may not be aware of all of the platform's capabilities. In some cases, the providers may not have the expertise to make the content available on the platform in the first place. Still further, the provider may provide incomplete content, where the platform requires or recommends that the provider add additional information in order to make the content accessible or more informative.

For example, an administrator for a business' social networking page may create a page for the businesssto, but may forget to create a separate user profile for the business. In some cases, the user profile may be required for the page to be functional; in other cases, providing a user profile may merely be a best practice. Or, the administrator may generate a user profile, but may forget to upload a picture to the profile.

In another example, the platform may provide an advertiser with the ability to “boost” their advertisement, or to take content such as a social networking post and turn that content into an advertisement that is made available to a broader user base. The advertiser may not know that this capability exists, or may not know the best time to employ it.

In situations like these, the provider may contact a help desk of the platform. This may trigger a fact-finding operation by the platform's help desk, where the help desk attempts to determine what the provider is attempting to do, what tasks the provider has already completed, and what information may have been omitted or entered incorrectly. Problematically, this help functionality is only useful to the provider if the provider knows that a problem exists (which is not always the case), how to contact the appropriate support, and how to describe the issue at hand.

### BRIEF DESCRIPTION OF THE DRAWINGS

FIG. 1A depicts an exemplary interface in which a helper bot makes a suggestion to a user.

FIG. 1B depicts the interface of FIG. 1A after the user responds to the helper bot.

FIG. 1C depicts the interface of FIG. 1B after the helper bot provides further assistance to the user.

FIG. 1D depicts an alternative interface that provides for automatic interaction between the helper bot and the platform;

FIG. 2A depicts an exemplary client/server architecture suitable for practicing exemplary embodiments;

FIG. 2B illustrates an embodiment of a consumer-to-business messaging system.

FIG. 2C illustrates an embodiment of a consumer-to-business messaging system processing a client inbox request.

FIG. 2D illustrates an embodiment of a subscription command in a consumer-to-business messaging system.

FIG. 2E illustrates an embodiment of a broadcast message in a consumer-to-business messaging system.

FIG. 3A depicts an exemplary message structure suitable for use with embodiments of the invention.

FIG. 3B depicts an exemplary context chain created based on message identifiers.

FIG. 3C depicts an exemplary context chain created based on message identifiers;

FIG. 4A is a data flow diagram depicting exemplary interactions between a client and a bot server.

FIG. 4B is a flowchart describing exemplary server-side operations for providing a helper bot.

FIG. 4C is a flowchart describing exemplary client-side operations for interacting with a helper bot.

FIG. 4D depicts exemplary client-side logic for interacting with a helper bot according to some embodiments;

FIG. 5A is a block diagram providing an overview of a system including an exemplary centralized messaging service;

FIG. 5B is a block diagram providing an overview of a system including an exemplary distributed messaging service;

FIG. 5C depicts the social networking graph of FIGS. 5A-5B in more detail;

FIG. 6 is a block diagram depicting an example of a system for a messaging service;

FIG. 7 is a block diagram illustrating an exemplary computing device suitable for use with exemplary embodiments;

FIG. 8 depicts an exemplary communication architecture; and

FIG. 9 is a block diagram depicting an exemplary multicarrier communications device.

### DETAILED DESCRIPTION

Messaging systems, such as instant messaging systems and short message service (“SMS”) systems, allow users to communicate with each other by exchanging messages. Messaging systems may allow a sending user to transmit messages to one or more receiving users. In some cases, messaging systems may allow a user to interact with messaging software that automatically converses with the user (known as a “bot” or “helper bot”).

Exemplary embodiments leverage bots to interact with platform users under certain triggered conditions. For example, the bots may converse with page admins and advertisers to assist them in managing their page profiles or advertisements. In one situation, an admin/advertiser may have a problem or may be able to optimize their page in some way, but may not know to search for the issue (or may not even know that they have a problem). In others, the admin/advertiser may initiate a process flow (e.g., creating a page profile or setting up content that could serve as an advertisement) without completing the process flow. For instance, a typical process flow for creating a profile might include: (1) creating a new profile; (2) providing a description of the entity associated with the profile; (3) uploading a picture to the profile; (4) providing active- or business-hours for the profile; (5) providing initial content for a page asssoicated with the profile; etc. In another example, an advertising process flow might include (1) creating content that could serve as an advertisement; (2a) initially flagging the content as an advertisement, or (2b) promoting the content to an advertisement at a suitable time; (3) specifying conditions for an advertising campaign, such as length, viewer target information, etc.; (4) initiating the campaign; (5) identifying when the campaign expires; and (6) optionally, renewing the campaign after expiration. In addition to guiding the user through these process flows, the helper bot may assist the user with particular steps (e.g., helping to identify a suitable picture for uploading to a profile, or identifying a particularly advantageous time or suitable viewer target information for an advertising campaign.

In exemplary embodiments, the user need not initiate a conversation with the helper bot, because the helper bot receives reports from the platform of platform events. When the event matches a triggering condition, the helper bot may send a message to guide the user through problem-solving scenarios.

The triggering conditions may include real-time events, such as when an advertiser creates an ad, a page administrator starts a predefined process flow (e.g., creating or updating a profile), or when a user sends a message that corresponds to an event. The triggering conditions may, in addition or in the alternative, include asynchronous events, such as events that are difficult to detect in real time (e.g., when an advertising campaign expires). The platform may periodically run checks to determine whether such events have occurred within a predetermined period of time, and may send reports to the bot provider upon detecting that such an event occurred.

The triggering conditions may be matched to a data structure that maps triggering conditions to conversations. For example, if the user begins a page creation process flow, this may be associated in the map with a predetermined set of messages that guide the user through the creation of a page.

The messages may be associated with media, such as text, tags, images, links, etc. The messages may also be associated with interactable elements that trigger the platform to take certain actions (e.g., opening dialogs, filling in forms with information provided in the conversation, etc.).

Triggered messages to the users can be delayed or sent under certain conditions to give opportunities for conversing while the user is active, without spamming the user. For example, the system may be provided with the user's active hours (e.g., inferring the hours by detecting the user's activity on the platform over a period of time, by receiving the hours from the user directly, by retrieving business hours from a page on the platform, etc.). The system may refrain from sending messages to the user outside of the user's active hours. Furthermore, if the user has been recently contacted by the helper bot (e.g., within a predetermined threshold period of time), the system may delay the sending of the message so as to avoid spamming the user.

When a message is triggered, a conversation between the user and a helper bot may ensue. The messages sent by the helper bot may have a unique format that allows the entire conversation to be represented as a chain encapsulating the entire conversation context. For example, the message may be associated with a communication identifier that uniquely identifies the communication. The communication identifier may be linked to a previous communication identifier in a chain that defines the context of a conversation.

The context may encompass, for example, what type of conversation is being carried out (e.g., page creation conversation, advertising campaign renewal conversation, etc.); which step of the conversation the user is currently engaged in; what previous actions were taken in furtherance of the goals of the conversation; and whether the conversation is expired or still relevant.

For instance, a communication identifier of “2” may be associated with a message that describes to a user how to upload a photo to their profile. The communication identifier of “2” may also be associated with a communication identifier of “1” that describes how to initially set up the profile. Because a photo cannot be added to a profile until the profile is created, communication 2 only occurs in a context where the actions described in communication 1 have already been carried out.

Given the above available messages, when a user initiates a process flow to create a page profile (e.g., selecting an option to “create a new profile” in the platform), the communications associated with communication identifier 1 may be sent to the user. Once the profile is created, the system may further guide the user through the addition of a photo to the profile by sending communications associated with communication identifier 2. On the other hand, if a user already has an active profile without an accompanying photo, the system may begin the conversation using the message(s) associated with communication identifier 2 (e.g., using an intermediate message of the conversation).

Moreover, identifiers that were previously associated with messages sent to the user may be retained by the system to identify what steps the user has already taken. Accordingly, if the user disengages and then re-engages with the platform, the system may retrieve the last identifier associated with a conversation with the user, and may use the associated context to identify a jumping-off point for engaging with the user (which may be in the middle of a conversation stored on the bot server).

Based on the current identifier associated with the conversation and any responses from the user, the bot may be able to determine which messages are most appropriate as a next step. For example, if the current conversation pertains to the uploading of a photo (identifier “2” above) and the system sends the message “First, click on the gear icon in the upper right corner of the screen to open the settings menu,” the user may respond with “OK, I'm there.” In this case, conversation logic may take into account the previous context (associated with identifier “2”) and the user's response, and may move on to the next step in the conversation. Alternatively, if the user says “I'm lost” or “I'm at the status update page,” the logic may trigger a different message that attempts to explain how to get to the settings menu more descriptively.

In some embodiments, machine learning may be employed to identify what other users of the platform are asking about or complaining about, and may derive problem-solving conversations from interactions between the other users and human help agents.

The helper bot may be agnostic as to the type of messaging platform used. The logic for triggering certain conversations may be stored at a server hosting the helper bot, and the bot may converse with different users through different messaging services (e.g., by calling appropriate commands from the messaging services' APIs). Accordingly, different platform developers may implement different bots, focusing on the problem-solving logic without being concerned for the specifics of making the bot interact with the user.

As described below, the helper bot may be programmed with logic to provide problem-solving conversations in connection with the management of advertising campaigns or social networking pages and profiles. For example, the helper bot may recommend that a user elevate a social networking post to an advertisement, start an advertising campaign at opportune times, restart an advertising campaign that has expired, create a page or a user profile, etc. In further embodiments, the helper bot may be leveraged to provide solutions such as real-time help for a variety of situations, intelligent FAQs or searching, calls to action, or any situation in which the developers of a platform or service may be privy to information about capabilities or functionality that a user might want to employ, but for which the user might not know to look up a solution (e.g., when page admins don't have the time or expertise to develop native user interfaces for the platform).

Still further, the bot may receive reports of user interactions with the platform (e.g., posting in the comments section of a particular page), and may make suggestions to the page administrator. For example, if a user posts a comment on a product manufacturer's page that evinces an intent to purchase the product, the bot may suggest to the page administrator that the administrator engage with the user. The administrator may give the bot permission to engage with the user on behalf of the administrator. Alternatively, the bot may be given permission to automatically initiate a conversation with the user in these circumstances, without seeking permission from the administrator.

This brief summary is intended to serve as a non-limiting introduction to the concepts discussed in more detail below. However, before discussing further exemplary embodiments, a brief note on data privacy is first provided. A more detailed description of privacy settings and authentication will be addressed in connection with the following Figures.

### A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for engaging in synchronous video conversation in a messaging system is next provided

As an aid to understanding, a series of examples and background information will first be presented before detailed descriptions of the underlying implementations are described. It is noted that these examples are intended to be illustrative only and that the present invention is not limited to the embodiments shown.

### Exemplary Interfaces

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

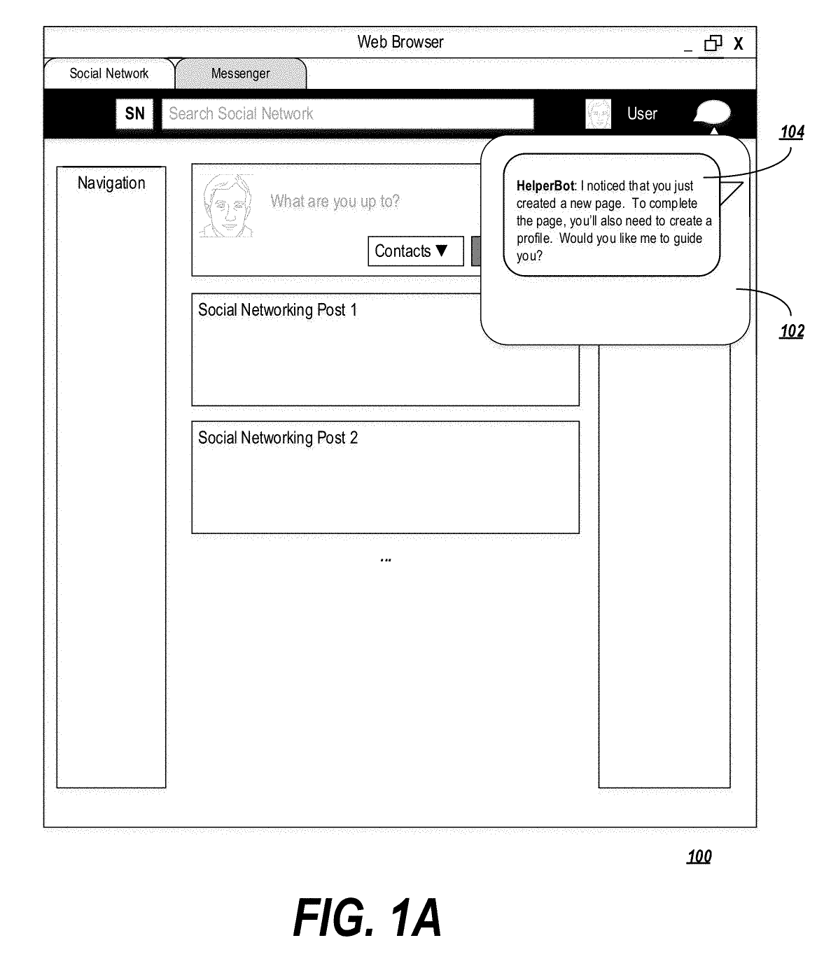

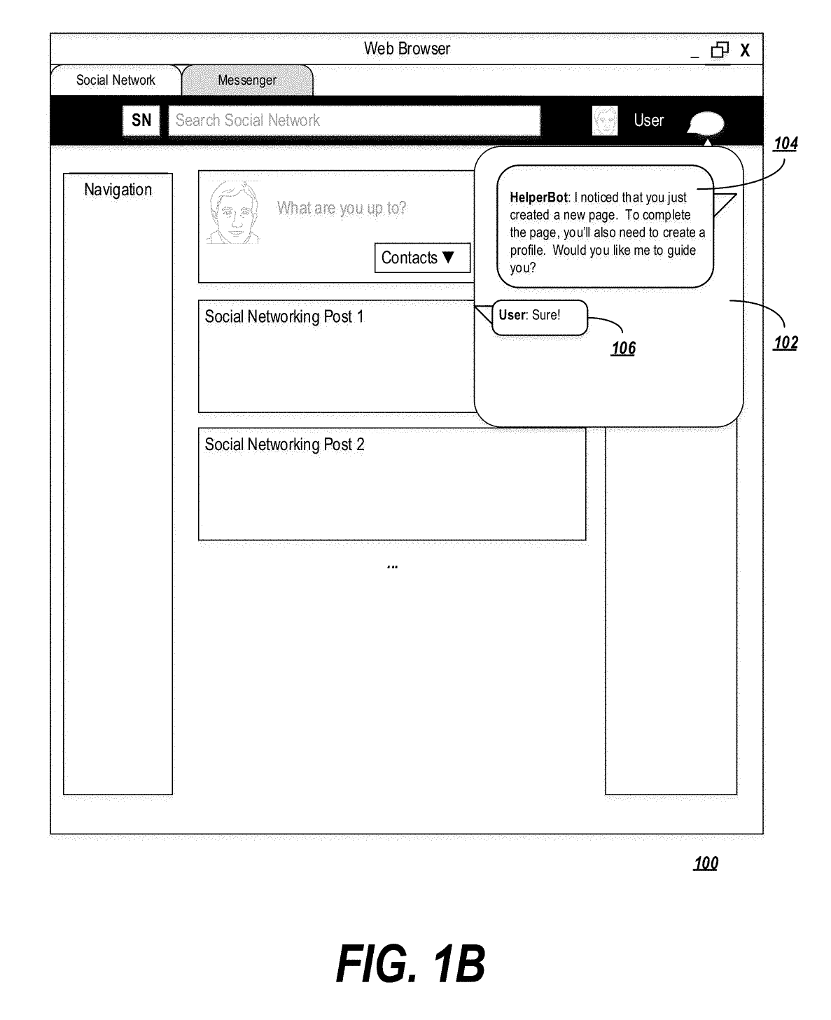

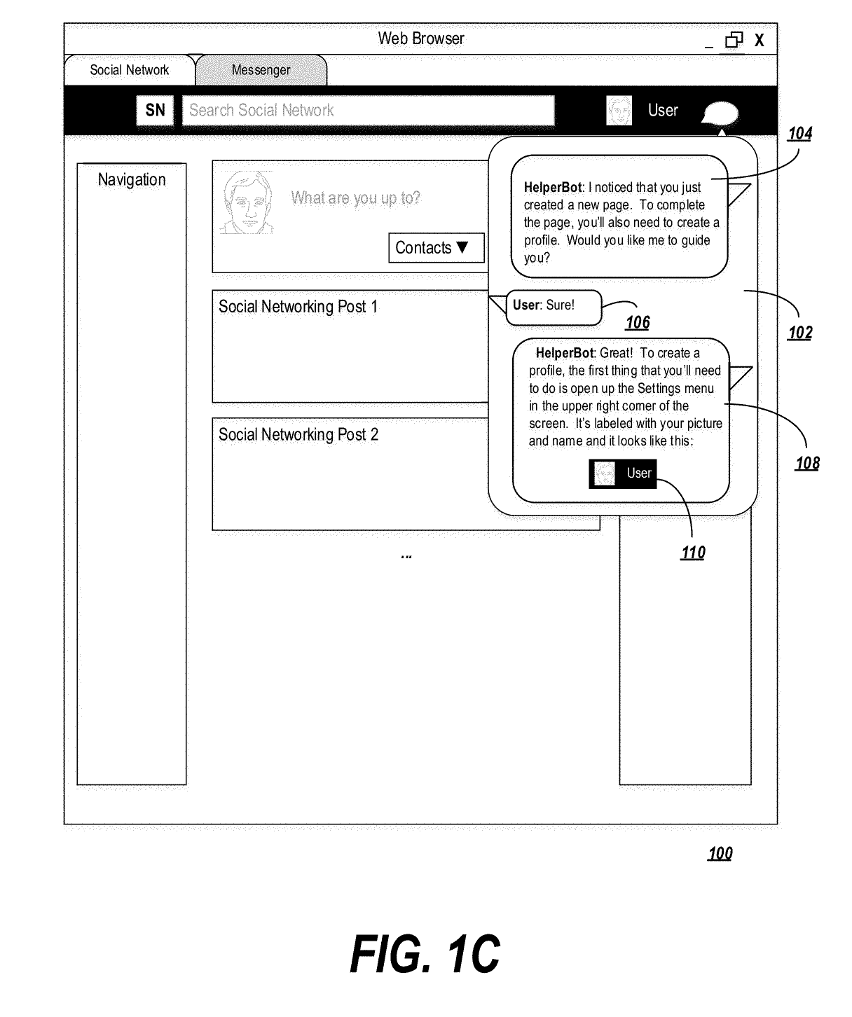

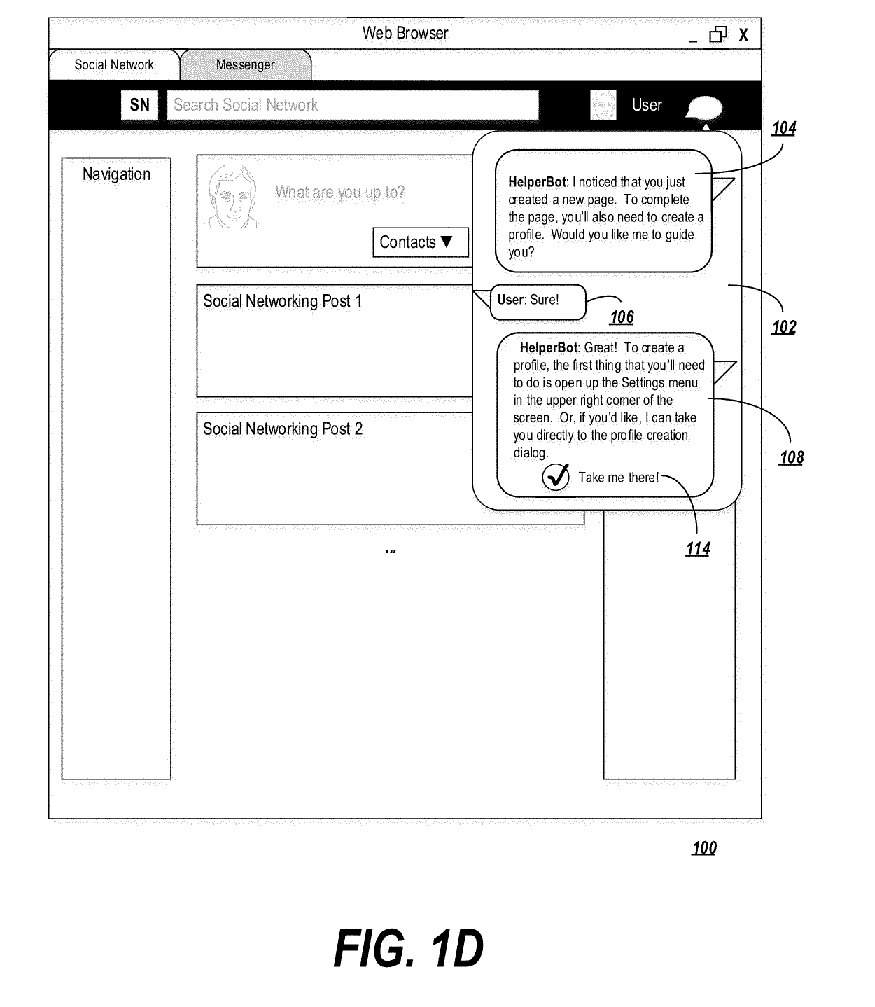

Users may interact with a messaging system through a platform, such as a client application. FIG. 1A depicts an exemplary platform interface 100 in which a helper bot makes a suggestion to a user. The platform interface 100 may be implemented by various client applications operative to provide a user with access to messaging system interfaces and/or functions, including, without limitation, a web browser application, a mobile application (“mobile app” or “app”), etc. Non-limiting examples of messaging system functions may include social networking services, messaging services, conversation services, content presentation services, etc. The platform interface 100 of FIG. 1A shows an exemplary message screen that includes interface elements (e.g., graphical user interface (GUI) objects) for a user to interact with the messaging system, and presents messages associated with the user (or the user's account or profile). In various embodiments, messages may include social networking posts, conversations (e.g., one-to-one conversations, group conversations, etc.), sent messages, received messages, user status information, etc. In some embodiments, platform interface 100 may include or may be a platform page, such as a profile page, a social networking page, a messaging page, an advertising page, etc.

The platform interface 100 may support automated user interaction with the messaging system via an automated conversation processes facilitated by a helper bot. In general, the helper bot may include, use, or otherwise access messaging software that automatically converses with the user responsive to one or more triggering conditions. For example, the helper bot may be programmed with logic to provide problem-solving conversations in connection with the management of platform components and functions, such as advertising campaigns or social networking pages and profiles. In further embodiments, the helper bot may be leveraged to provide solutions such as real-time help for a variety of situations, intelligent FAQs or searching, calls to action, or any situation in which the developers of a platform or service may be privy to information about capabilities or functionality that a user might want to employ, but for which the user might not know to look up a solution (e.g., when page admins don't have the time or expertise to develop native user interfaces for the platform).

In exemplary embodiments, the platform may generate a report of a status of a user interaction with the platform (a “platform interaction”). The report may be or may include information, data, signals, etc. indicating particular platform interactions, for example, a user commencing or continuing a platform function, including starting a predefined process flow. Non-limiting examples of a predefined process flow may include creating or modifying a page, creating or modifying a profile, creating or modifying an ad, sending a message, establishing a relationship, uploading content, generating a social network post, etc. In this manner, the user need not initiate a conversation with the helper bot, because the helper bot receives reports from the platform of platform events and may automatically start a conversation responsive to the report indicating a triggering condition.

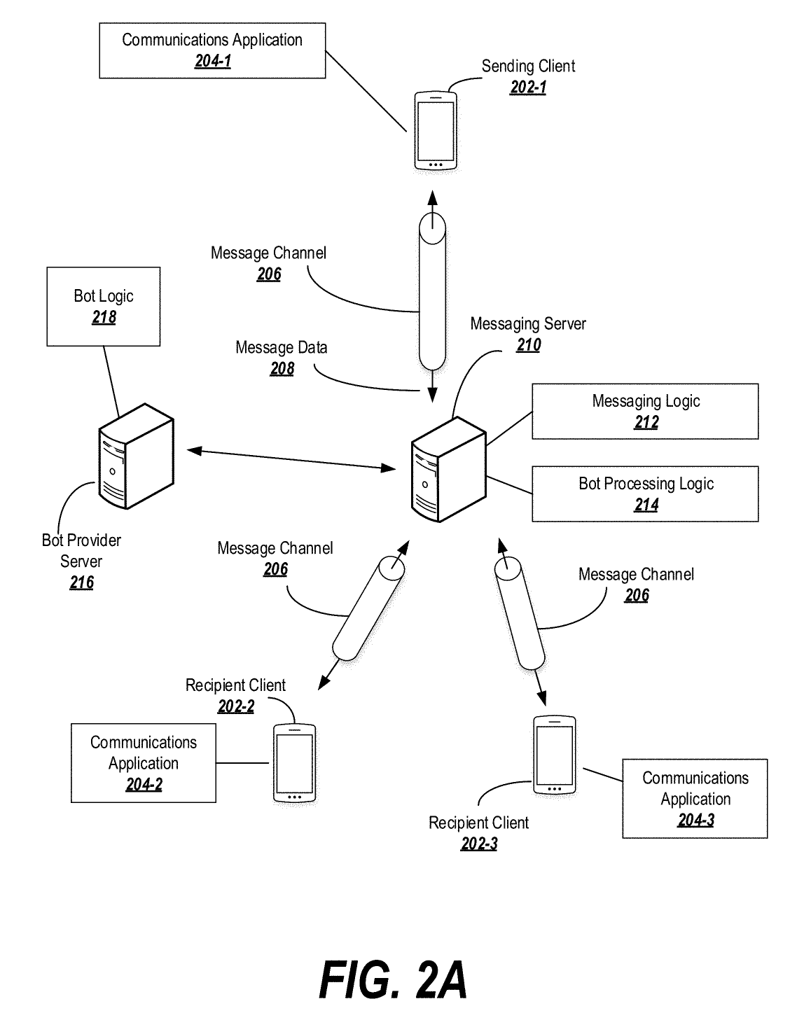

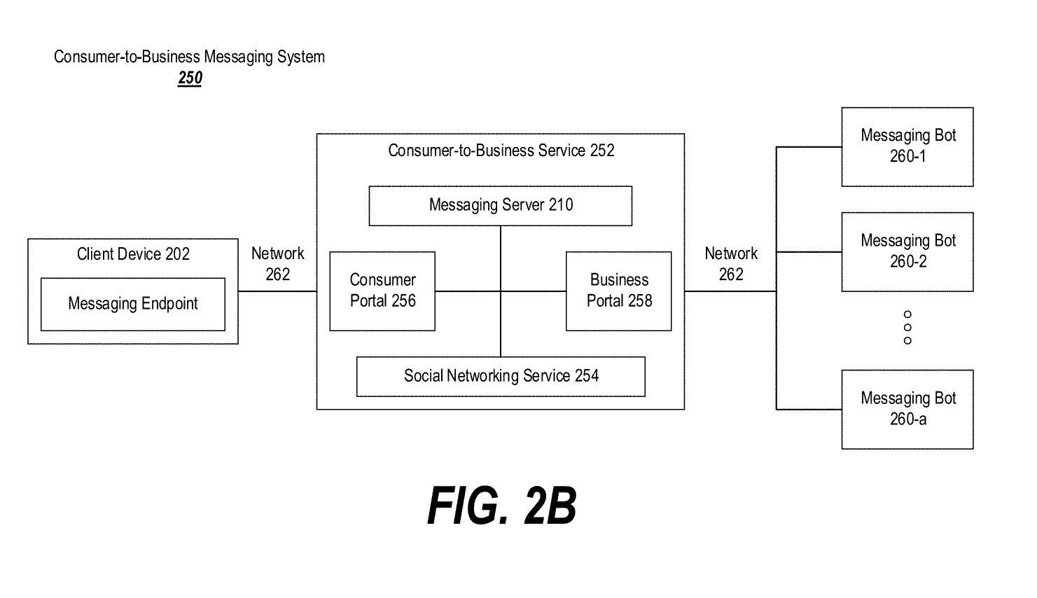

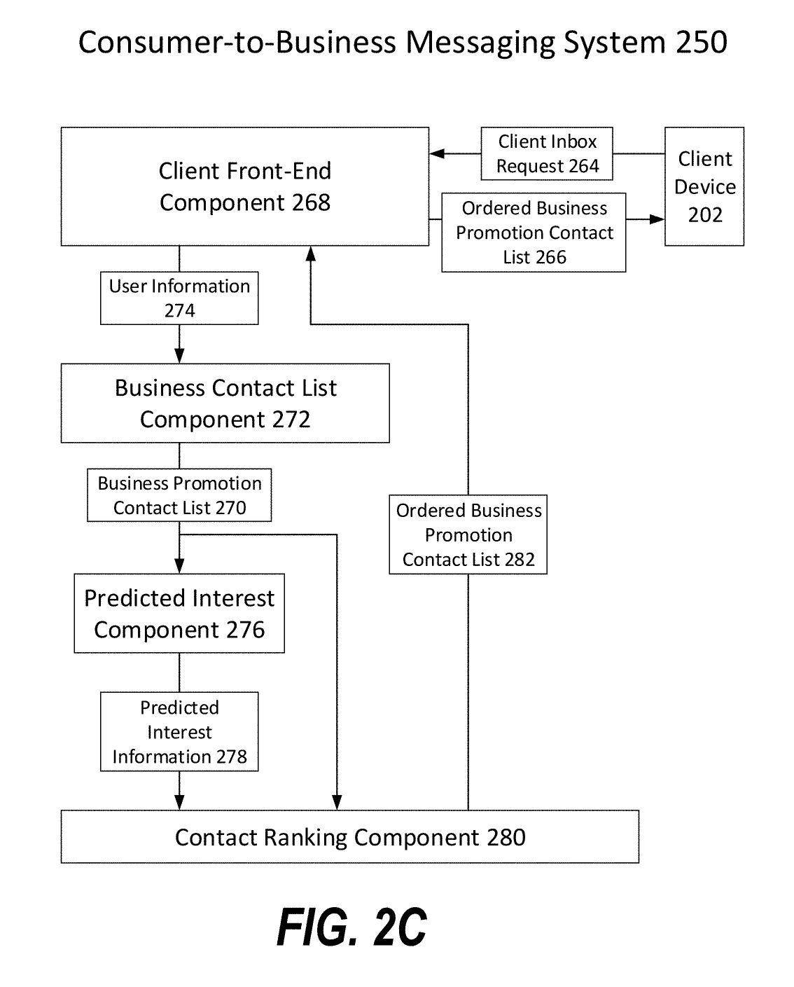

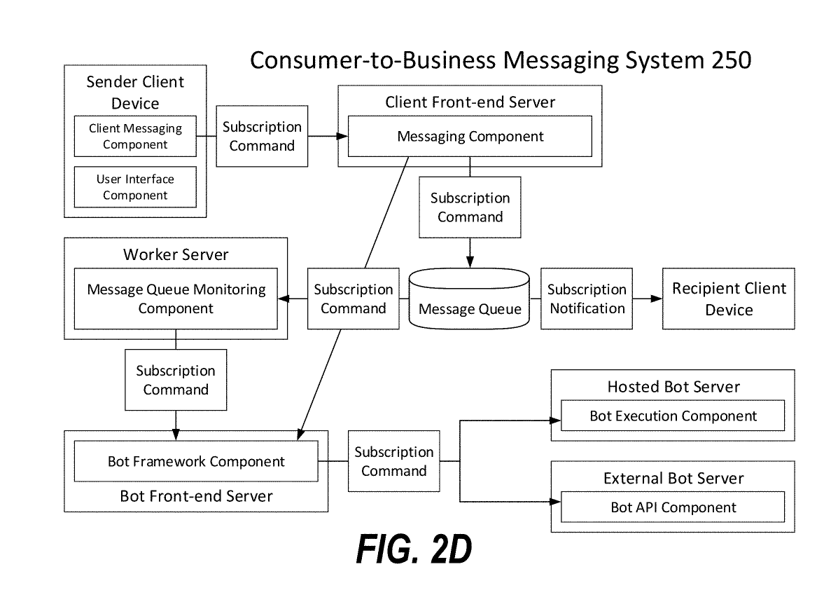

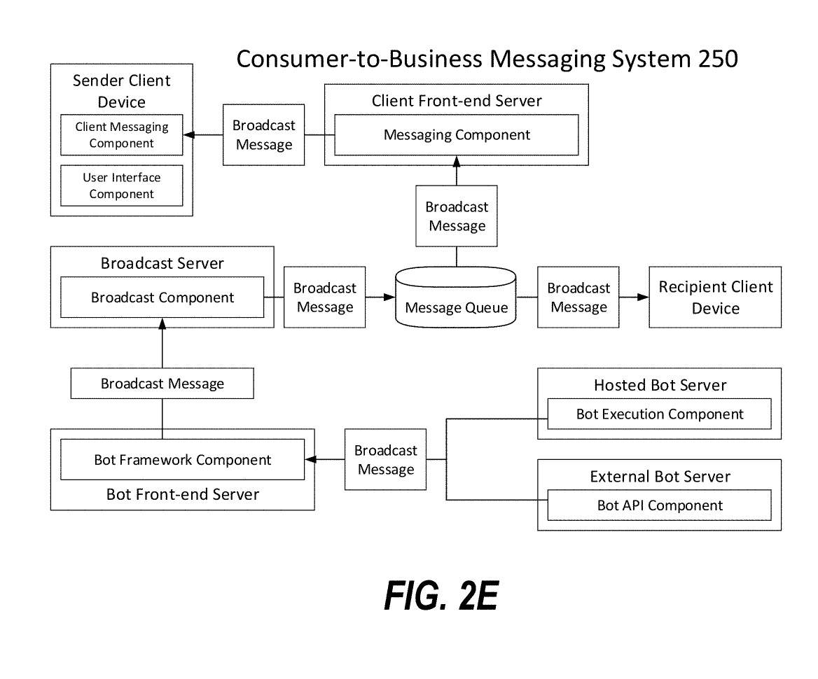

For example, a platform server (e.g., alone or in combination with a messaging server such as messaging server 210 of FIG. 2A) managing functions on the platform may monitor user interactions and generate a report having a status indicating a user interaction on the platform (e.g., creating a new page). The platform server may provide the report to a server managing helper bot services (e.g., a “bot provider server” or “bot server,” such as bot provider server 216 of FIG. 2A). In exemplary embodiments, the bot helper may be implemented via logic executed on the platform server, messaging server, the bot server, and/or a combination thereof. The bot server may determine whether the status associated with the report (e.g., user has created a new page) matches a triggering condition. A triggering condition may include predefined events or conditions, for instance, real-time (or substantially real-time) events such as when an advertiser creates an ad, a page administrator starts a predefined process flow (e.g., creating or updating a profile), or when a user sends a message that corresponds to an event. Non-limiting examples of triggering conditions may include creating a profile, modifying a profile, setting a profile status, creating a message, receiving a message, creating a social networking post, modifying a social networking post, receiving a social networking post, participating in a conversation (e.g., with a user or a bot), ending a conversation, creating an advertisement or campaign, modifying an advertisement or campaign, expiration of a time-based component (e.g., expiration of an advertising campaign, calendar event, etc.), creating a calendar event, receiving a calendar invite, creating a relationship, deleting a relationship, etc. In exemplary embodiments, a triggering condition may include the absence of an expected second event following a first event (e.g., following expiration of a predetermined time period), response to a helper bot message, etc. For instance, a triggering condition may include the absence of a response to a calendar invite 48 hours after receiving the calendar invite (e.g., indicating that the user may need assistance with this function). In another instance, the triggering condition may include absence of a response to a social networking post relating to an advertised product within 12 hours. In a further instance, a triggering condition may include the creation of a platform page without creating an associated profile. Embodiments are not limited in this context.

The triggering conditions may, in addition or in the alternative, include asynchronous events, such as events that are difficult to detect in real. In some embodiments, an asynchronous event may include a change in platform status that are aggregated (e.g., at various time intervals) and sent as a status in one or more reports. For example, an advertising campaign may expire and, at a certain time period (e.g., the end of the business day), the system identifies all the campaigns that are no longer active and sends a report to the bot server (which might initiate a helper bot recommending that the user re-instate the campaign based on certain conditions).

Although a platform server and a bot server are used to implement the helper bots described in certain examples, embodiments are not so limited. For instance, the helper bot may be agnostic as to the type of network configuration and/or messaging platform used. The logic for triggering certain conversations may be stored at the bot server, the platform server, a messaging server, and/or a combination thereof, and the helper bot may converse with different users through different messaging services (e.g., by calling appropriate commands from the messaging services' APIs). Accordingly, different platform developers may implement different helper bots, for example, focusing on the problem-solving logic without being concerned for the specifics of making the helper bot interact with the user according to exemplary embodiments.

The platform may run checks periodically and/or responsive to user-initiated platform interactions (e.g., selecting a “create page” object) to determine whether certain events have occurred (and within a predetermined period of time as necessary), and may send reports to the bot server upon detecting that such an event occurred. In exemplary embodiments, the triggering conditions may be matched to a data structure that maps triggering conditions to conversations. The data structure may be or may include a status map. In various embodiments, the status map may include triggering conditions and associated conversations. The status map may be configured to associate the status as a triggering condition with a conversation for a helper bot.

In exemplary embodiments, at least a portion of the triggering conditions of the status map may be associated with one conversation. In various embodiments, at least a portion of the triggering conditions of the status map may include a plurality of conversations selected based on one or more factors. Non-limiting examples of factors may include (estimated or determined) user expertise, past triggering conditions, number of past user conversations, active platform functions, user response/message contents, etc.

When the status of the report matches a triggering condition, the helper bot may initiate a conversation 102 (or messaging thread) with the user. In exemplary embodiments, the helper bot may retrieve a communication associated with the conversation, such as a first helper bot message 104, for presentation via the platform interface 100. For example, if the user begins a page creation process flow, this may be associated in the map with a page creation triggering condition (e.g., when the user creates a social networking page without creating a user profile). The page creation triggering condition may be associated with a page creation conversation including a predetermined set of communications or messages that guide the user through the creation of a page.

The communications, such as the first helper bot message 104, sent by the helper bot may have a unique format that allows the entire conversation 102 to be represented as a chain encapsulating the entire conversation context. For example, the first helper bot message 104 may be associated with a communication identifier that uniquely identifies the communication. The communication identifier may be linked to a previous communication identifier in a chain that defines the context of a conversation 102. In various embodiments, the context may encompass, for example, type of conversation being carried out (e.g., page creation conversation, advertising campaign renewal conversation, etc.); steps of the conversation the user is currently engaged in (e.g., message 2 of 5); previous platform interactions taken in furtherance of the goals of the conversation; and whether the conversation is expired or still relevant. For instance, a communication identifier of “2” may be associated with a message that describes to a user how to upload a photo to their profile. The communication identifier of “2” may also be associated with a communication identifier of “1” that describes how to initially set up the profile. Because a photo cannot be added to a profile until the profile is created, communication 2 only occurs in a context where the actions described in communication 1 have already been carried out. On the other hand, if a user already has an active profile without an accompanying photo, the system may begin the conversation using the message(s) associated with communication identifier 2 (e.g., using an intermediate message of the conversation).

In exemplary embodiments, the bot helper (e.g., via bot server) may determine delay conditions associated with a triggering condition, conversation, message, etc. In general, a delay condition may include a condition indicating that the bot helper should delay initiating or continuing a conversation, for example, to ensure the user is active and/to avoid spamming the user. For example, the bot server may be provided with the user's active hours (e.g., inferring the hours by detecting the user's activity on the platform over a period of time, by receiving the hours from the user directly, by retrieving business hours from a page on the platform, etc.). In another example, the bot server may be provided with an indication of the user's activity level (e.g., messaging activity, web browsing, email activity, etc.) and may delay initiating or continuing a conversation if the activity level is above a threshold. The system may refrain from sending messages to the user outside of the user's active hours. In addition, if the user has been recently contacted by the helper bot (e.g., within a predetermined threshold period of time), the system may delay the sending of the message so as to avoid spamming the user. Furthermore, the delay conditions may include explicit and/or implicit user preferences. For example, the user may specify to delay helper bot conversations 102 until after business hours. In another example, an implicit preference may be determined based on activity in which the user only engages in helper bot conversations during a certain time period.

In some embodiments, the helper bot may be operative to assist a page owner or administrator with creating, configuring, updating, or modifying a page. In further embodiments, the helper bot may be operate to assist a non-owner or non-administrator page visitor (e.g., a user having friend-level or public-level access to the page). In various embodiments, an administrator may create or grant permission for a helper bot initiated responsive to a visitor performing an action on the page, such as a social network post, marking a post (e.g., “liking” a post), selecting a link, etc. For example, a page administrator may configure a helper bot or may activate a pre-configured (or partially pre-configured) helper bot capable of providing instruction for a visitor that comments on a social network post on the page to obtain further information, speak with an employee, purchase a product, etc.

In further embodiments, the helper bot may receive reports of statuses that include user interactions with the platform (e.g., posting in the comments section of a particular page), and may make suggestions to the page administrator. For example, if a user posts a comment on a product manufacturer's page that evinces an intent to purchase the product, a report may be generated with a status indicating that the user posted the comment with respect to the product. A helper bot may be initiated to suggest to the page administrator that the administrator engage with the user. In some embodiments, the administrator may give the helper bot permission (e.g., explicitly in response to an alert, or implicitly via profile settings) to engage with the user on behalf of the administrator. Alternatively, the bot may be given permission to automatically initiate a conversation with the user in these circumstances, without seeking permission from the administrator

The user may interact with the helper bot and/or conversations thereof. FIG. 1B depicts the interface of FIG. 1A after the user responds to the helper bot. In exemplary embodiments, the user may provide a user message 106 in response to the first helper bot message 104. In this manner, the user may interact with the helper bot to move the conversation 102 forward. In some embodiments, the entry of the user message 106 into the conversation 102 and the content of the user message 106 may be logged by the platform server and/or messaging server and provided as a report of the status to the bot server. The bot server may determine whether the status of the report associated with the user message 106 is a triggering condition.

Based on the current identifier associated with the first helper bot message 104 the user message 106, the bot helper may be able to determine which messages are most appropriate as a next step in the conversation 102. In exemplary embodiments, the content of the use message (e.g., “Sure!”) may be analyzed to determine a type of response, such as an affirmative response to continue the conversation, a negative response that the user is not interested in continuing the conversation, an ambiguous response (e.g., triggering the helper bot to request more information), a request for information from the user, etc. In an exemplary embodiment, if the user had provided a negative response to the first helper bot message 104, the helper bot may close the conversation 102 and provide a default message (e.g., “If you need help with this action in the future, select “helper bot” for assistance”) and/or a feedback request (e.g., “Are you declining the conversation because (a) you know how to perform this function, (b) not interested in helper bot assistance, etc.). In some embodiments, a conversation message, such as the first helper bot message 104, may include interactive GUI objects that allow a user to make a selection, such as checkboxes, radio buttons, etc.

The response to feedback may be provided to the status map for handling future triggering conditions. As shown in FIG. 1B, the user message 106 indicates an affirmative response that the user is interested in continuing the conversation. Accordingly, the triggering condition may include an affirmative response to the first helper bot message 104, more specifically, an affirmative response to message identifier “x” (e.g., the message identifier of the first helper bot message 104) of the conversation associated with triggering condition “y” (e.g., creating a page without a user profile). The platform server may transmit a report of the status of an affirmative response to the first helper bot message 104 to the bot server.

In exemplary embodiments, identifiers that were previously associated with messages sent to the user may be retained (e.g., by the platform server and/or bot server) to identify what steps the user has already taken. Accordingly, if the user disengages and then re-engages with the platform after user response 106, the system may retrieve the last identifier associated with the conversation 102, and may use the associated context to identify a jumping-off point for engaging with the user (e.g., the second helper bot message 208).

FIG. 1C depicts the interface of FIG. 1B after the helper bot provides further assistance to the user. The helper bot may provide a second helper bot message 108 responsive to the trigger condition associated with user response 106. For example, the second helper bot message 108 may include information for performing a function associated with the conversation 102, such as creating a profile. The second helper bot message may include one or more steps for performing or commencing the function, such as the step of opening a settings menu presented on the platform interface 100 to initiate creating a profile.

In exemplary embodiments, the helper bot and/or platform server may monitor events during the active conversation to continue the conversation 102 (which may include user messages within conversation 102). For example, if the user performs an action, a report of the status (e.g., action A has been executed) may be generated and transmitted to the bot server. The bot server may determine a triggering condition associated with the status. For example, if the user performs the action of opening the settings menu, the triggering condition may be associated with a message to present a next step to the user. Based on the current identifier associated with the conversation and any responses from the user, the helper bot may be able to determine which messages are most appropriate as a next step.

For example, if the current conversation pertains to opening the setting menu (e.g., identifier A) and the system sends the message “To create a profile, the first thing that you'll need to do is open the Settings menu in the upper right corner of the screen,” the user may respond with “OK, I'm there” or open the settings menu as instructed. In this case, helper bot conversation logic may take into account the previous context (associated with identifier A) and the user's response, and may move on to the next step in the conversation. Alternatively, if the user responds with a negative indication (e.g., says “I'm lost” or “I'm at the <incorrect> page”) or performs the incorrect action (e.g., selects to navigate to another page), the helper bot conversation logic may trigger a different message, such as a further explanatory message that attempts to explain how to get to the settings menu more descriptively. In exemplary embodiments, machine learning may be employed to identify what other users of the platform are asking about or complaining about with respect to a conversation, message, etc., and may derive problem-solving conversations from interactions between the other users and human help agents. For example, if it is determined that a low percentage of users (e.g., based on a threshold) elect to perform the action instructed in the second helper bot message 208 or do not complete the steps of conversation 102, the bot server may make a determination, for example, to automatically modify the conversation (e.g., introduce interactive objects) and/or alert a platform developer.

As shown in FIG. 1C, helper bot messages may include objects 110, such as files, media, links, pictures, documents (or links to documents), etc. For example, the second helper bot message 108 includes an image 110 used to provide a visual aid for the user to perform the step instructed in the second helper bot message 108. In exemplary embodiments, the objects 110 and/or information associated with the objects 110 (e.g., metadata) may be stored at the platform server, for example, with data associated with the conversation 102.

In exemplary embodiments, a user may interact directly with helper bot messages, for example, to perform various actions within the platform. FIG. 1D depicts an alternative interface that provides for automatic interaction between the helper bot and the platform. The second helper bot message 108 includes an interaction or interactable element 114 operative to perform an action on the platform (e.g., opening dialogs, filling in forms with information provided in the conversation, etc.). In some embodiments, the interactable element 114 may be configured to perform a specified action based on a context, such as an action specified for the interactable element 114 and/or an action associated with the second helper bot message 108. The interactable element 114 may have various forms according to exemplary embodiments. Non-limiting examples of interactable element 114 may include buttons, check boxes, radio buttons, yes/no or green/red selection objects, etc.

Selecting the interactable element 114 in the context of FIG. 1D may result in the helper bot causing the platform to open a profile creation page without the user having to take any direct action (e.g., selecting objects to open the profile creation page) with the platform (beyond selecting the interactive element 114). In exemplary embodiments, selection of interactable element 114may trigger a report of the status indicating that the user wants to perform the function associated with interactable element 114 and/or the second helper bot message 208.

### Exemplary Bot Server and Client System and Information Exchange

FIG. 2A depicts an exemplary system including clients 202-i and at least one server 210 for processing bot messages.

The clients 202-i may be mobile devices, such as phones, tablets, etc., and may be equipped with touch-sensitive displays capable of registering haptic feedback. The clients 202-i may be provided with respective communications applications 204-i, such as applications that allow the clients 202-i to access the capabilities of a messaging service or other type of communications service (e.g., a live video broadcasting service, a video calling service, etc.).

The clients 202-i may communicate with the server 210 through one or more channels. For example, a message channel 206 may carry message data pertaining to synchronous or asynchronous information transmitted from the communications application. The messages may be, for example, messages in a messaging service associated with a conversation through a thread ID.

A messaging server 210 may receive the message data 208, process the data, and forward it to appropriate recipients. For example, the messaging server 210 may retrieve a thread ID from a message 208 determine a set of participants associated with the thread ID, and forward the data to the client devices 202-i of the participants. To this end, the messaging server 210 may include messaging logic 212 for processing message data 208. At the receiving client side, each recipient client 202-i may include a communications application 204-i configured to process messages and drawing data and to display the messages on a communications viewer interface.

The messaging server 210 may further be configured to process bot messages using the techniques described herein. Accordingly, the messaging server 210 may include bot processing logic 214 for performing any of the techniques described herein.

To receive bot messages and media items, the messaging server 210 may communicate with one or more bot provider servers 216. The bot provider servers 216 may transmit messages and /or media items to the messaging server 210. To this end, the bot provider server 216 may include bot logic 218 configured to interact with one or more users in a conversation.

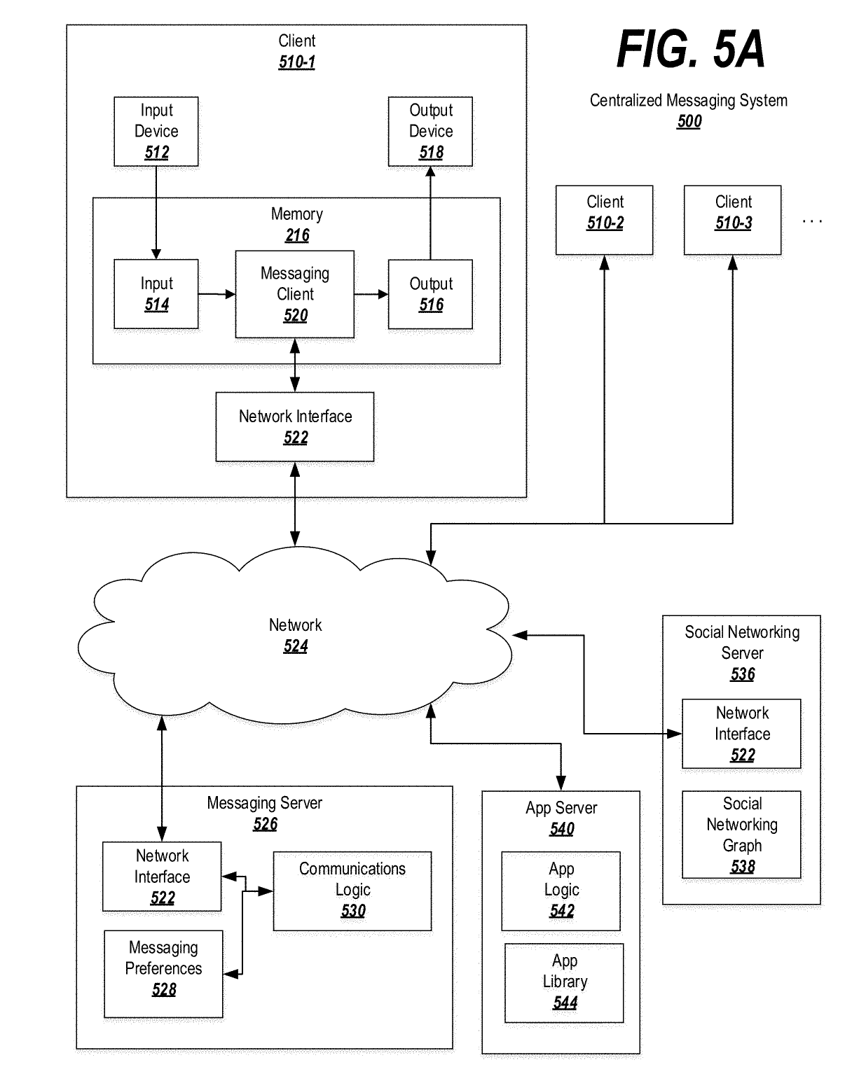

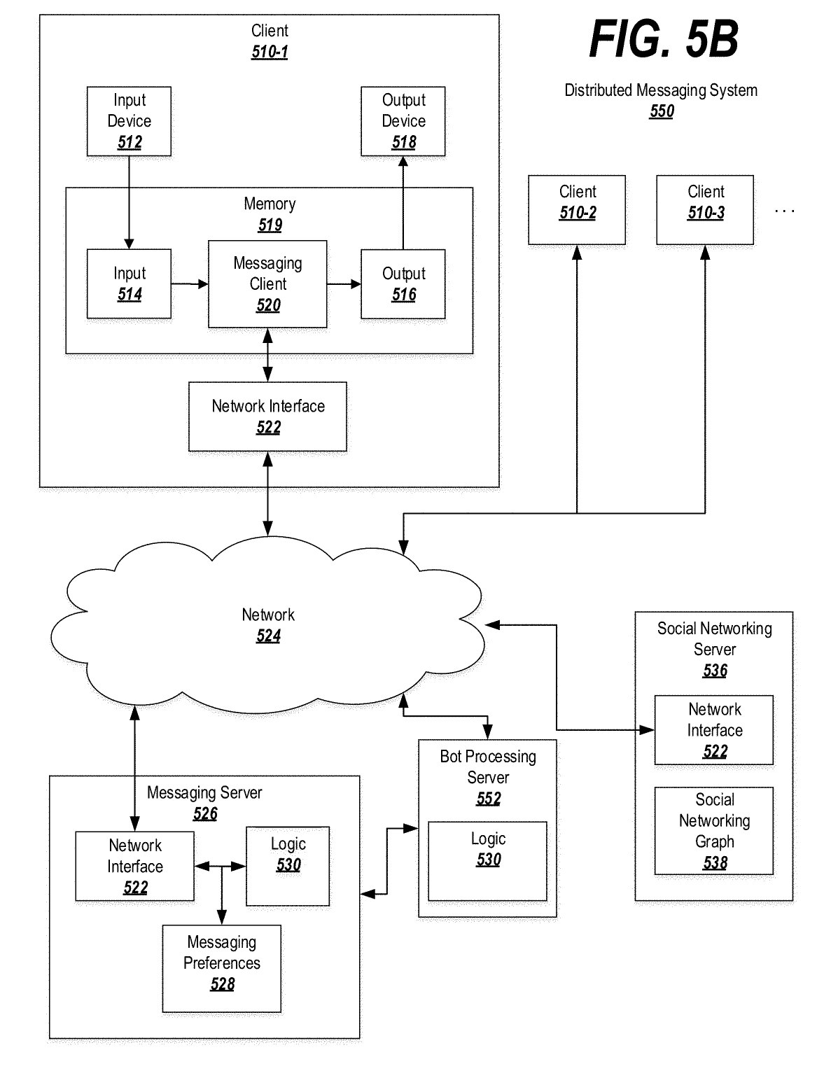

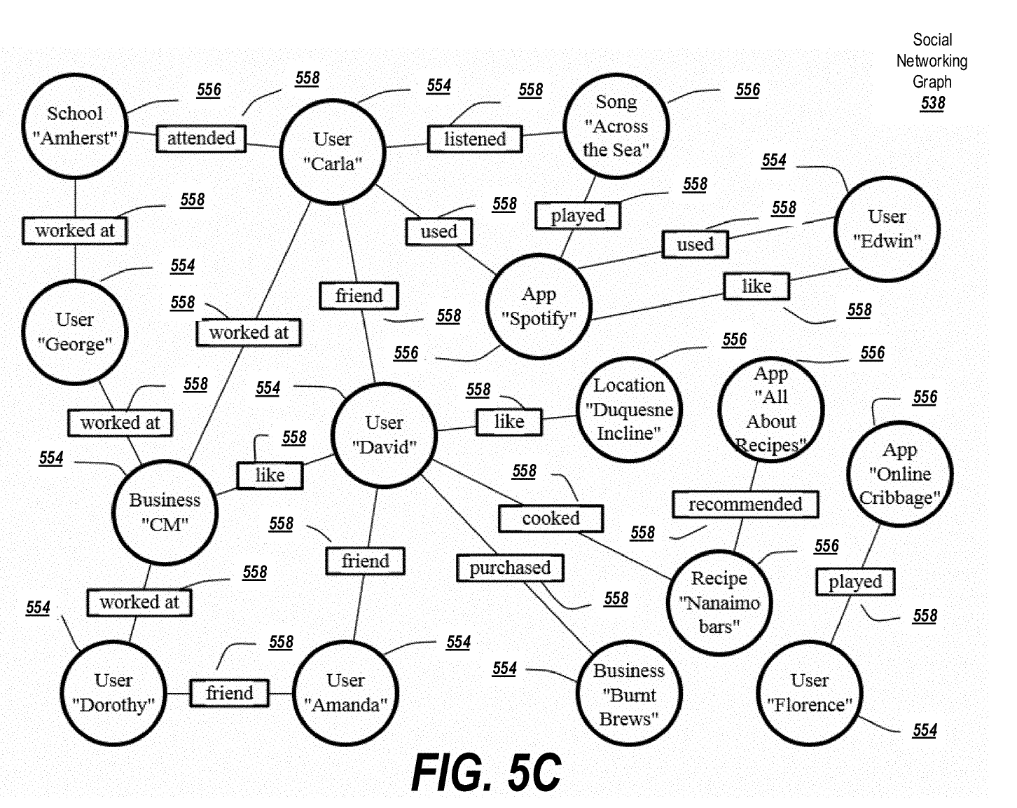

Alternatively, as described in more detail in connection with FIG. 5B below, a separate bot processing server may be provided in communication with the message server 210. The bot processing server may provide capabilities for processing bot messages on behalf of the messaging service, and may thus include the bot processing logic 214.

In one embodiment, the system of FIG. 2A may be provided as part of a consumer-to-business messaging system 250, as shown in FIG. 2B. In one embodiment, the consumer-to-business messaging system 250 may comprise a computer-implemented system having software applications comprising one or more components. Although the consumer-to-business messaging system 250 shown in FIG. 2A has a limited number of elements in a certain topology, in other embodiments the consumer-to-business messaging system 250 may include more or fewer elements in alternate topologies as desired for a given implementation.

A consumer-to-business service 250 may serve as an intermediary between consumers and businesses. Consumers and businesses may both be users of the consumer-to-business service 250, with consumers represented via an individual user account and businesses represented by a commerce account and, possibly, one or more individual user accounts associated with the business, such as individual user accounts associated with representatives and other employees of the business. A consumer user may be represented with a user entity in a social graph (see FIG. 5C). A business or other commercial user may be represented by a business entity in a social graph. The relationship between the consumer user and the commercial user may be represented by one or more edges between the user entity and business entity in the social graph.

The consumer-to-business service 252 may comprise a messaging system such as the messaging server 210. The messaging server 210 may be generally arranged to receive, store, and deliver messages between individual entities such as individual users and collective entities such as businesses and other organizations. The messaging server 210 may store messages while messaging endpoints, such as the communications application 204 (FIG. 2A), are offline and deliver the messages once the messaging endpoints are available. The messaging server 210 may empower a user to use multiple messaging endpoints (e.g., a messaging client on a mobile device, a web browser on a personal computer) for the same user account, with the messaging server 210 keeping all of the messaging endpoints up-to-date as to the messaging state of the user account.

The consumer-to-business service 252 may comprise a social networking service 254. The social networking service 254 may maintain a social graph data structure representing a social graph. The social graph may represent relationships between entities, such as user entities, commerce entities, and any other sort of entity. The social graph may represent the relationships as graph relationships, in which all information is encoded as either being attached to a particular node in the graph or attached to a particular edge between two nodes in the graph. A messaging service including the messaging server 210 may be an element of a social networking service 254, with the social graph containing, at least in part, social-networking information. The whole of the consumer-to-business service 252 may be an element or composed of elements of a social networking service.

The consumer-to-business service 252 may comprise a consumer portal 256. The consumer portal 150 may be a unified entry point into the consumer-to-business service 252 for client applications being used by consumers. The consumer portal 256 may serve as a general user portal for non-commerce entities, including users that are not or do not engage in commerce using the consumer-to-business service 252. The consumer portal 256 may provide access to the messaging server 210 and the social networking service 254. In some embodiments, all access to the social networking service 254 may be mediated by the consumer portal 256 in which the information of the social networking service 254 is used and managed on behalf of the user without the user having direct access to some or all of the social graph information. In some embodiments, the user may have direct access to the messaging server 210 using their user account, with the consumer portal 256 limited to consumer functions of the consumer-to-business service 252 with general messaging functionality (e.g., messaging with friends) provided through direct network communication between the messaging endpoint and the messaging server 210 without the mediation of the consumer portal 256.

The consumer-to-business service 252 may comprise a business portal 258. The business portal 258 may be a unified entry point into the consumer-to-business service 252 for client application being used by business entities. The business portal 258 may provide access to the messaging server 210 and the social networking service 254. In some embodiments, all access to the social networking service 254 may be mediated by a business portal 258 in which the information of the social networking service 254 is used and managed on behalf of the business entity without the business entity having direct access to some or all of the social graph information. In some embodiments, the business entity may have direct access to the messaging server 210 using their commerce account, with the business portal 258 limited to business functions of the consumer-to-business service 252 with general messaging functionality (e.g., messaging with customers) provided through direct network communication between one or more messaging bots 260 and the messaging server 210 without the mediation of the business portal 258.

A user may participate in the consumer-to-business messaging system 250 and interact with the consumer-to-business service 252 using a messaging endpoint software application executing on a client device 202. The client device 202 may typically be a smartphone—a mobile phone capable of executing software applications that provide functionality beyond that of a conventional telephone—such as an iPhone®, Android® phone, or other smartphone. The messaging endpoint may be specifically associated with a particular messaging server 210 that forms part of the consumer-to-business service 252 or may be a general-purpose messaging client operative to interact with a plurality of messaging services. The messaging endpoint may interact with one or both of the consumer portal 256 and the messaging server 210 for the performance of messaging tasks and commerce tasks.

A business entity may be represented in a messaging system by a commerce representation comprising a collection of information for display to a user. A commerce representation may comprise a business page, the business page being the identity of a business within the consumer-to-business messaging system 250. The business page may display information regarding a business entity. The business page may include information for the business entity, such as one or more of a physical location for the business entity, the operating hours of the physical location, or the hours in which the business entity (e.g., a representative of the business entity) is available for messaging through the consumer-to-business messaging system 250. The business page may include social-networking information for the business entity, such as a list of friends of a viewing user that have “liked” or “followed” the business entity within a social network as may be represented in a social graph.

A commerce representation may not correspond precisely to a business entity. A single business entity, such as a business, may have multiple commerce representations and therefore multiple business pages. For example, a single business may have different representations for different brands owned and operated by the same business. A retailer or reseller may sell multiple brands and may have different representations for different brands that they sell. A business may have different representations for different geographic areas in which they operate, such as one business page for the United States, another for Europe, another for Russia, etc.

To aid a user in interacting with a service within a messaging context, services may be represented as messaging bots 190 within a messaging system. A messaging bot may be a fully or partially automated front-end to a network-accessible service that can be represented as a participant within a message thread. In some cases, a messaging bot may be corresponded with in a message thread that explicitly includes the messaging bot, such as a one-on-one message thread between a particular user and the messaging bot. In other cases, a messaging bot may be corresponded with in a message thread in which the messaging bot is not a regular participant, the messaging bot a temporary participant in the message thread for the purposes of interacting with the service. The messaging bot may be included as a temporary participant in any other thread, whether a one-on-one thread between two users or a group thread between more than two users.

A messaging bot for a commerce representation may be presented in a messaging conversation in a messaging system. A user of the messaging system may interact with a business by messaging with the messaging bot that comprises a virtual representation of the business. A messaging bot may specifically correspond to a commerce representation presented as a business page, with the messaging bot being the representation of the business page in a messaging context. Messaging with the bot may therefore extend the presence of a commerce representation from a business page, primarily dedicated to providing information from the business to users, to interactive messaging in which users and the business can engage in a conversation.

A business may use one or more commerce applications to engage with the messaging server 210. An application may correspond to a specific registration empowering access to the messaging server 210 and/or social networking service 254 via an application programming interface (API). An application may be registered with the messaging server 210 via various registered hooks for the application specifying how the application can be contacted by the messaging server 210. These hooks may be used to contact the application in response to events, such as user messaging, within the messaging system. An application may be assigned a secure token that may be used for authentication and the secure (e.g., encrypted) reception and sending of information with the messaging server 210. An application may correspond to a specific AppID with the messaging server 210 and/or social networking service 254. Because the business may surface multiple aspects of the services and products it provides via the agent, multiple different applications may be used by a business entity to interact with a user via the messaging server 210. Each application may be subscribed with the messaging server 210 to the one or more commerce representations, such as business pages, that it powers.

The network 262 may comprise any form of computer network operative to carry computer transmissions between computer devices. The network 262 may include one or both of intranets and the Internet. The network 262 may include cellular data and/or Wi-Fi data networks, such as may be used to provide connectivity to a mobile client device 202.

The consumer-to-business messaging system 250 may use knowledge generated from interactions between users. The consumer-to-business messaging system 250 may comprise a component of a social networking service 254 and may use knowledge generated from the broader interactions of the social networking service 254. As such, to protect the privacy of the users of the consumer-to-business messaging system 250 and the larger social networking service 254, consumer-to-business messaging system 250 may include an authorization server (or other suitable component(s)) that allows users to opt in to or opt out of having their actions logged by the consumer-to-business messaging system 250 or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of the consumer-to-business messaging system 100 and other elements of a social networking service 254 through blocking, data hashing, anonymization, or other suitable techniques as appropriate. For example, while interactions between users of a social networking service 254 and the social networking service 254 may be used to learn media content preferences and the relationship between preferences for different pieces of content, these interactions may be anonymized prior to or as part of the learning process.

FIG. 2C illustrates an embodiment of a consumer-to-business messaging system 250 processing a client inbox request 264.

The consumer-to-business messaging system 250 may comprise a plurality of components. The consumer-to-business messaging system 250 may be operative to provide an ordered business promotion contact list 266 to a client device 202. The ordered business promotion contact list 266 may configure the client device 202 for display of the promoted business contacts according to ranking weights, the ranking weights determined according to a function including a predicted business messaging interest representing a prediction of a user's interest in messaging with the suggested business contacts.

The consumer-to-business messaging system 250 may comprise a client front-end component 268. The client front-end component 268 may be generally arranged to exchange information with client devices to empower the client devices to engage in messaging activity using a messaging system. The client front-end component 268 may provide access to various messaging services and/or social networking services. The client front-end component 268 may provide access to the retrieval of a messaging inbox. The client front-end component 268 may provide an ordered business promotion contact list 266 to a client device 202. The retrieval of a messaging inbox may include the retrieval of the ordered business promotion contact list 266 automatically or the ordered business promotion contact list 266 may be performed via a distinct client inbox request 264.

The client front-end component 268 may receive a client inbox request 264 for a user account from a client device 202. The user account may be an account registered with a messaging system. A client inbox request 264 may be a request for updates to an inbox. Alternatively, a client inbox request 264 may be distinct from a request for updates to an inbox. In some embodiments, a request for an ordered business promotion contact list 266 may be sent in coordination with a request for updates to an inbox so as to empower the display of the ordered business promotion contact list 266 in association with an inbox.

The client front-end component 268 may transmit an ordered business promotion contact list 266 to the client device 202 in response to the client inbox request 264. The ordered business promotion contact list 266 may be ordered for display for the user account based on a determined ranking weight for each business contact on the ordered promotion contact list 266. The ordered business promotion contact list 266 may be ordered for display to the user account in association with a messaging interface for the messaging system.

Each business contact on a business promotion contact list 270 and ordered business promotion contact list 266 may be associated with a business page comprising business information with the messaging system 140. Each business contact on the business promotion contact list 270 and ordered business promotion contact list 266 may be operative to open a message thread with the business contact when selected, such as by being associated with a control for opening the message thread.

In some cases, a client device 202 may engage in a business contact search. The client front-end component 268 may interact with the client device 202 to support the business contact search. The client front-end component 268 may suggest responses to the business contact search. The client front-end component 268 may interact with the client device 202 to order a type-ahead for a search entry form for the messaging system based on the ranking weight. The results for a business contact search may include performance information for the one or more discovered business contacts. Performance information may include a display of an average response time for the business, such as may be determined according to analysis of the actual performance of a messaging bot by the messaging system.

The consumer-to-business messaging system 250 may comprise a business contact list component 272. The business contact list component 272 may be generally arranged to retrieve and manage contact information for a user account. The contact information may include both user contacts (other non-business users of the messaging system) and business contacts. The business contact list component 272 may be operative to determine a business promotion contact list 270 for the user account. The business contact list component 270 may receive user information 274 from the client front-end component 268 identifying the user account for a client device 202. For instance, the user information 274 may comprise a user identifier uniquely identifying the user account within the consumer-to-business messaging system 250.

The business contact list component 272 may determine a business promotion contact list 270 for the user account. The business contact list component 272 may exclude recently-active business contacts from the business promotion contact list 270. Recently-active business contacts may comprise business contacts with which the user has engaged in messaging interactions within a predefined time period, within a predefined recency. Recently-active business contacts may comprise a predefined number of the most-recent business contacts with which the user has engaged. These techniques may be combined.

A user account may be associated with one or more friends with a messaging system. In some embodiments, a user's friends with a messaging system may correspond to or include a friends list for a social networking service. A user's friends may also include contacts specifically with the messaging system.

A business promotion contact list 270 may be generated based on the business messaging patterns for a user and/or a user's friends. The business promotion contact list 270 for the user account may incorporate business contacts from a variety of sources. The business promotion contact list 270 for the user account may incorporate a list of business contacts the user account has messaged with via the messaging system. The business promotion contact list 270 for the user account may incorporate a list of business contacts the user account has liked with the messaging system. The business promotion contact list 270 for the user account may incorporate a list of business contacts the friends of the user account have messaged with via the messaging system. The business promotion contact list 270 for the user account may incorporate a list of business contacts the friends the user account have liked with the messaging system. The business promotion contact list may comprise a joining of one or more of these sources and may include business contacts from additional or alternative sources.

The business promotion contact list 270 may be generated by forming a core corpus of business contacts and then expanding the corpus to include additional business contacts similar to the contacts from the starting corpus. The business contact list component 272 may start by generating a seed business promotion contact list for the user account. The seed business promotion contact list may be based on a list of business contacts the user account has messaged with via the messaging system. The seed business promotion contact list may additionally or alternatively be based on a list of business contacts the friends of the user account have messaged with via the messaging system. The business contact list component 272 may receive user information 274 comprising a list of business contacts the user account has been used to message with via the messaging system and/or a list of business contacts the friends of the user account have messaged with. This list, or a joining of these lists, may comprise the initial corpus of business contacts.

The business contact list component 272 may then expand the seed business promotion contact list to generate the business promotion contact list 270. The business contact list component 272 may include additional business contacts with similar features to the business contacts on the seed promotion contact list. Each business contact may have features, such as may be defined according to a social graph for a social networking service 254. Business contacts may be connected based on having similar features. The weight of features—their importance in creating connections—may be determined based on machine-learning clustering of business contacts. In some cases, this clustering may be specific to particular demographics, such that different clusterings or different connections between business contacts are used for different groups of people. A machine learning component may determine feature weights for expanding the seed business promotion contact list based on a machine learning analysis of a messaging history for the messaging system. The business contact list component 272 may expand the seed business promotion contact list based on the feature weight. In some embodiments, the feature weights may be general across all users of the messaging system. In other embodiments, the feature weights may be selected as corresponding to particular profile information for the user, such as may include age, gender, location (e.g., city, state, country, or other region), or other information known about a user.

The consumer-to-business messaging system 250 may comprise a predicted interest component 276. The predicted interest component 276 may be generally arranged to determine predicted interest information 278 for a user in relation to business contacts based on user information for users of the consumer-to-business messaging system 250. The user information may comprise social-networking information for a social networking service 254, such as may derived from a social graph. The predicted interest component 276 may generate predicted interest information 278 for the user and provide the predicted interest information 278 to the contact ranking component 280. The predicted interest information 278 may be generated according to known techniques for generating predicted interest. The predicted interest component 276 may be operative to determine a predicted communication interest for each business contact on the promotion contact list 270 for the user account.

Machine learning may be used to determine a user's predicted business messaging interest for each business contact. A messaging history for a messaging system may be used to match profile features for users to business features for businesses to predict a user's interest in messaging with a business contact. A predicted interest component 276 may receive one or more business features for each business contact on the business promotion contact list and receive one or more profile features for one or more users of the messaging system. The predicted interest component 276 may receive a messaging history for the messaging system, with the messaging history comprising historical information about various users engagement with businesses via the messaging system. The predicted interest component 276 may generate a predicted business messaging interest model for the messaging system based on a machine learning analysis of the messaging history, with the predicted business messaging interest model based on the one or more profile features and the one or more business features. The predicted interest component 276 may thereafter determine the predicted business messaging interest for each business contact on the business promotion contact list based on the predicted business messaging interest model.

In some cases, a predicted commerce communication interest may be used to generate suggested business contacts for engaging in two-way commerce interactions. In some cases, a predicted subscription communication interest may be used to generate suggested business contacts for engaging subscriptions. These cases may be used alternatively or in combination, with only one type of suggestions being presented to a user for a client device 202 or both types of suggestions being presented.

Different aspects of commercial engagement may be predicted. A predicted business messaging interest model may predict user interest in beginning a messaging interaction with a business, such as opening a message thread with a messaging bot and/or sending a message to a messaging bot via the message thread. A predicted business messaging interest model may predict user interest in requesting a service via the messaging interaction with the business. A predicted business messaging interest model may predict user satisfaction from requesting the service via the messaging interaction with the business, such as may be determined based on user feedback. Each of these measures may be tracked for users of the consumer-to-business messaging system 250. These measures may be matched to user information for a user account—such as biographical information, contextual information, and/or interest information—using machine learning techniques to determine predicative user features for one or more of the measures, as represented in the predicted business messaging interest model. In some embodiments, a single measure may be used for a user's interest. In some embodiments, the measures may be combined to generate an overall interest. This model may then be applied to the user information for a user account to generate the predicted interest information 276 for the user account.

Different aspects of subscription engagement may be predicted. A predicted business messaging interest model may predict user interest in subscribing with a business, as measured by user subscriptions. A predicted business messaging interest model may predict user time spent reading subscription messages from the business, as measured by time spent in a messaging client in the message thread for the messaging bot. A predicted business messaging interest model may predict user responsiveness to subscription notifications for the business, such as the frequency and speed with which users respond to notifications delivered for received subscription messages. A predicted business messaging interest model may predict user blocking of the business, with this measure taken as a negative indication for the messaging bot. Each of these measures may be tracked for users of the consumer-to-business messaging system 250. These measures may be matched to user information for a user account—such as biographical information, contextual information, and/or interest information—using machine learning techniques to determine predicative user features for one or more of the measures, as represented in the predicted business messaging interest model. In some embodiments, a single measure may be used for a user's interest. In some embodiments, the measures may be combined to generate an overall interest. This model may then be applied to the user information for a user account to generate the predicted interest information 278 for the user account.

Promoted business contacts may be generated with information received from outside the messaging system. A messaging history may include one or more of a short message service (SMS) messaging history and a phone record history. The predicted interest component 276 may generate a predicted business messaging interest model for the messaging system based on a machine learning analysis of the messaging history and a web contact history. The predicted business messaging interest model may, for instance, recommend businesses or types of businesses that a user has previously SMS messaged or called.

A machine learning model may be used once a messaging history for messaging bot engagement has been established. However, during an initial period for the consumer-to-business messaging system 250 the suggestions may instead be based on heuristics. This initial period may be used to build a messaging history for messaging bot engagement, allowing for a transition to a machine learning model.

A heuristic may provide the predicted business messaging interest for each business contact on the business promotion contact list 270. The predicted business messaging interest may be based on a business responsiveness rate, a business responsiveness speed, and a friend engagement measure for each business contact. The business responsiveness rate may be a measure of what percentage of the user messages sent to a messaging bot are responded to by the business. The business responsiveness speed may comprise a measure, such as an average, of the time between the sending of user messages and the response by the messaging bot where a response is received. The friend engagement measure may comprise a measure of whether friends for the user account on the messaging system have liked the business contact with the messaging system. Alternatively or additionally, the friend engagement measure comprising a measure of whether friends for the user account on the messaging system have messaged with the business contact via the messaging system. Where the friend engagement measure comprises a measure of whether friends for the user account have messaged with the business contact, a particular degree of messaging engagement may be used, such as any engagement at all (sending any message whatsoever to the messaging bot) or actually engaging the messaging bot in a service, without limitation.

The predicted business messaging interest may specifically be based on a linear function of the business responsiveness rate, the business responsiveness speed, and the friend engagement measure for each business contact. The linear function may be determined based on a linear regression of a historical data set for the messaging system. Initially, the linear function may be manually configured. The consumer-to-business messaging system 100 may then switch to the use of a historical data set once user interactions have been gathered. The use of heuristics with an early historical data set may be used to transition from a hand-tuned predicted business messaging interest generation to a model in which linear regression is used to tune parameters of a linear function and then ultimately to a full machine-learning system. The linear function may be trained on the historical data set to select and score highly those business contacts that users eventually engage with. Machine learning may determine weights for the business responsiveness rate, the business responsiveness speed, and the friend engagement measure prior to the user engaging with the business contact that maximize the accuracy of predicting the eventual engagement by the user.

In some cases, a predicted business messaging interest model may be additionally based on a user context. This user context may comprise a current user location. For instance, nearby businesses may be suggested for messaging. Alternatively or additionally, businesses relevant to the user's current location may be suggested. For example, a user at an airport may be suggested taxi, ride sharing, or other local transportation options. In some embodiments, machine learning may include a current user context when learning what businesses to recommend, such that businesses receive an increased ranking weight when a location that is learned to be relevant to the businesses is present in the user context. In some embodiments, types of businesses may be manually or automatically configured to receive a higher ranking weight in certain locations, such as local transportation options when at an airport, train station, or other long-distance transportation location.

A contact ranking component 280 may determine a ranking weight for each business contact on the business promotion contact list 270 based on the predicted business messaging interest for each business contact. In some cases, the predicted business messaging interests may each comprise a numerical score, this numerical score used as the ranking weight. However, in some cases, the ranking weight may be reduced for one or more previously-viewed business contacts of the business promotion contact list. The ranking weight may be reduced for the one or more previously-viewed contacts by a linear multiplier based on a number of viewings. The contact ranking component 280 may track the number of times a contact is included in a business promotion contact list 270 and use this number as the number of viewings. Alternatively, the client device 202 may track the number of times a promoted business contact is actually displayed to the user and provide it to the consumer-to-business messaging system 250 for use as the number of viewings. The contact ranking component 280 may order the business promotion contact list 270 for display for the user account based on the determined ranking weight for each business contact on the business promotion contact list to generate the ordered business promotion contact list 282.

In some embodiments, other information about a contact may be incorporated into the ranking weight. The consumer-to-business messaging system 250 may increase the ranking weight for a business contact based on a short messaging service (SMS) history for the user account indicating short messaging service messaging with the business contact. In some cases, the predicted interest component 276 may increase the predicted interest based on the SMS history. Additionally or alternatively, the ranking weight may receive an additive or multiplicative boost based on the existence of a SMS history between the user and the business contact. This may serve to promote transition from the use of SMS to the use of messaging using a messaging system.

FIG. 2D illustrates an embodiment of a subscription command in a consumer-to-business messaging system 250.

A messaging system may comprise a plurality of components. In some embodiments, these plurality of components may be distributed among a plurality of servers. In other embodiments, a single server may implement the plurality of components. In some embodiments, a plurality of servers may be executed by a single server device. In other embodiments, the plurality of servers may be executed by a plurality of server devices. In some embodiments, multiple instances of the various components and various servers may be executed to provide redundancy, improved scaling, and other benefits. Similarly, a client device may execute a plurality of components as part of a messaging client.

A client device may communicate with other devices using wireless transmissions to exchange network traffic. Exchanging network traffic, such as may be included in the exchange of messaging transactions, may comprise transmitting and receiving network traffic via a network interface controller (NIC). A NIC comprises a hardware component connecting a computer device, such as client device, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API). The network interface controller may be used for the network activities of the embodiments described herein, including the interoperation of the messaging client and messaging servers through network communication. For example, the messaging client transmitting or receiving messages to or from a client front-end server 535 may be interpreted as using the network interface controller for network access to a communications network for the transmission or reception of information.

A messaging client may comprise a user interface component. A user interface component may be generally arranged to display user interfaces to a user of a client device and to receive user commands for the messaging client for the client device. A messaging client may comprise a client messaging component. A client messaging component may be generally arranged to conduct messaging interactions on the behalf of the messaging client via communication with the client front-end server.

A client front-end server may be generally arranged to act as a network access point to the messaging system for client devices such as sender client device. The client front-end server may comprise a messaging component, the messaging component generally arranged to act as a network access point to messaging services for the messaging system. The messaging component may receive messages from client devices and add the messages to message queues.

A message queue may be specifically associated with the user of sender client device, such as by being uniquely associated within the messaging system with a user account for the user of sender client device. The message queue may be a single queue used for all messaging endpoints used by this user. The message queue may comprise a representation of updates in a strict linear order. The message queue may be organized as a data unit according to a variety of techniques. The message queue may be stored in semi-persistent memory, persistent storage, both semi-persistent memory and persistent storage, or a combination of the two. The message queue may be organized according to a variety of data structures, including linked lists, arrays, and other techniques for organizing queues. The message queue may generally comprise a first-in-first-out (FIFO) queue in which no update will be removed or retrieved from the queue before any updates that were received prior to it.

The messaging system may comprise a worker server. In general, the messaging system may comprise a plurality of worker servers that may be assigned to various tasks. A worker server may comprise a message queue monitoring component, the message queue monitoring component arranged to monitor updates, such as may comprise messages, in the message queue and other message queues of the messaging system for various flags, indicators, and other information.

The messaging system may comprise a bot front-end server. A bot front-end server may act as an access point to messaging bot services for the consumer-to-business messaging system. The bot front-end server may act as an intermediary between the servers of the messaging system and one or more internal and/or external bot execution servers. The bot front-end server may comprise a bot framework component generally arranged to provide an accessible framework to the messaging bot system.

In some cases, messaging bots may be executed by servers external to the consumer-to-business messaging system, such as an external bot server operated by the service associated with the bot. The bot framework component may determine an external bot server for the service associated with the messaging bot. The bot framework component may submit messages to the messaging bot by sending the messages to the external bot server associated with the messaging bot. In some embodiments, submitting messages may comprise extracting message content and transmitting the message content to the external bot server using a bot server interaction application programming interface (API). Bot messages from the messaging bots may similarly be received by the bot framework component from an external bot server.

In other cases, messaging bots may be executed by the servers of the consumer-to-business messaging system. The bot framework component may determine a hosted bot server for the service associated with a messaging bot. A hosted bot server may comprise a bot server maintained by the provider of the consumer-to-business messaging system. The bot framework component may submit messages to the messaging bot by sending the messages to the hosted bot server associated with the messaging bot and may receive messages from the messaging bot by receiving them from the hosted bot server.

Users of the consumer-to-business messaging system may be empowered to subscribe message threads to bots to be pushed updates from the bots. In some cases, a subscribed message thread may be a user-to-bot message thread particular for the user to that messaging bot. In other cases, a user-to-user message thread, including both message threads between a pair of users and group message threads, may be subscribed to messaging bots. A subscription to a bot may authorize the bot to transmit messages to the subscribed message thread. This authorization may have restrictions, such as having a limited number of subscription messages that may be sent within a given time period. For example, a messaging bot may be restricted to sending at most one message a day or a specific number of messages a day. In some embodiments, subscriber thread preferences for a user may specify a restriction on the frequency with which a messaging bot may message a message thread.

A subscription command may instruct a messaging system and the messaging bot that the message thread associated with the message subscription command should receive subscription messages from the messaging bot. A bot framework component may subscribe the message thread to the messaging bot in response to the bot subscription command. In various embodiments, the subscription command may be transmitted directly from the client messaging component to the bot framework component, may be transmitted directly from the messaging component to the bot framework component, or may be detected in the message queue and thereby communicated to the bot framework component.

The subscription command may also be received by a recipient client device, such as every recipient client device for users involved in the message thread subscribed by the subscription command. The subscription command may be communicated to a recipient client device as a notification in the message thread that the message thread has been subscribed to the messaging bot. In general, any member of a message thread may subscribe the thread to a messaging bot, unsubscribe the thread from the messaging bot, or modify the subscriber thread preferences for the message thread's subscription to the messaging bot. Any of these actions may result in a notification message being added to the message queue for each member of the message thread, the notification message communicating the action, whether subscription, un-subscription, or modification of subscriber thread preferences.

Subscriptions may be maintained in a subscription registry. A subscription registry may map between thread identifiers that uniquely identify message threads within the messaging system 140 and subscriptions to messaging bots. A subscription registry may comprise, without limitation, a database or database table with a row for each registered subscription. Each registered subscription may be associated with subscriber thread preferences for that subscription.

A messaging component may receive a bot subscription command for a user account with a messaging system from a sender client device, the bot subscription command specifying a messaging bot. The bot subscription command may be received based on a bot recommendation interface displayed on the sender client device in a user interface component. A bot recommendation interface may comprise a plurality of business contacts in a business promotion contact list. The business promotion contact list may be configured based on a predicted business messaging interest model, wherein the predicted business messaging interest model predicts one or more of user interest in subscribing with a business, user time spent reading subscription messages from the business, user responsiveness to subscription notifications for the business, user unsubscribing for channels for the business, and user blocking of the business.

A bot subscription command may be received in association with an information display associated with the messaging bot in a news feed interface. A social networking service may provide a news feed to users of the service, the news feed comprising news feed items. News feed items may be generated based on status changes, postings, and other information generated by users of the social networking service. In some cases, users may post content received based on a subscription to the social networking service, with the service possibly thereafter adding the content to the news feeds of one or more friends of the user in the service. The posted content may be associated with a display indicating the messaging bot, and possibly in addition the interest for the messaging bot, that brought the posted content to the attention of the posting user via a subscription. This display may include a control empowering the user to subscribe to the messaging bot directly from the news feed, which may result in the subscription command.

A bot subscription command may be received in association with a web page display associated with the messaging bot. A user may view a web page for an article. The article may be associated with the messaging bot by virtue of comprising content that may also be delivered by the messaging bot. The web page may advertise that the messaging bot is available for receiving content such as the article, and may include a web plugin comprising a control empowering subscription to the messaging bot. In some cases, an article may be reached via a news feed, such as by appearing as an item in a news feed, being selected by the user, with the user then directed to a web page display for the article. Where an article is reached via a news feed, the web page display may include a header, footer, frame, or other visual element for the social networking service. This header, footer, frame, or other visual element may include a display of a messaging bot is available for receiving content such as the article or that the messaging bot is responsible for the posting user having added the article to the news feed. A control may be associated with this display empowering the user to subscribe to the messaging bot directly from the news feed, which may result in the subscription command. In some cases, the messaging bot channel may be determined as a broadcast channel associated with the web page display.

The bot framework component may determine a messaging bot channel for the messaging bot. The messaging bot channel may correspond to an interest of a plurality of interests support by the messaging bot. In some cases, the messaging bot channel may be automatically determined as a default messaging bot channel for the messaging bot, with the user then able to select what one or more interests for the messaging bot they want to subscribe to. For example, a user may deselect their subscription to the default messaging bot channel and select one or more other messaging bot channels for their subscription.

A user may be able to configure the interests that they want to subscribe to. The bot framework component may receive a bot subscription command for the user account, subscribe the user account to the messaging bot channel for the messaging bot in response to the bot subscription command, and send a subscription configuration package to the client device for the user account. The subscription configuration package may comprise a listing of a plurality of messaging bot channels for the messaging bot, the subscription configuration package operative to configure the client device for the selection of one or more selected messaging bot channels of the plurality of messaging bot channels. The user may be displayed a list of the messaging bot channels available for a messaging bot and to select one or more of the channels for subscription. The bot framework component may determine the messaging bot channel for the messaging bot based on the one or more selected messaging bot channels.

The subscription configuration package may be for display during an initial display of a messaging bot thread for the messaging bot. For instance, a user subscribing to the messaging bot from a news feed or web page display may be subscribed and sent the subscription configuration package. The client device for the user may receive the subscription configuration package and instantiate a message thread for the messaging bot in the messaging client. The messaging client may display the messaging bot channel options when the message thread is selected on the client device.

Users may be empowered to block messaging bots that they have subscribed to. The messaging component may receive a block command in association with the user account for the messaging bot and block communication from the messaging bot for the user account. Because the messaging bot is blocked, the user may no longer receive content from the messaging bot. As such, the bot framework component may unsubscribe the user account from any messaging bot channel for the messaging bot in response to the block command.

The consumer-to-business messaging system may attempt to avoid supporting messaging bots that result in as drastic a user action as blocking the bot, rather than merely unsubscribing from the bot. The bot framework component may determine a block rate for the messaging bot and flag the messaging bot for review when the block rate exceeds a predefined threshold. A moderator of the consumer-to-business messaging system may be presented with information for the messaging bot, including one or more of the block rate, subscription rate, unsubscription rate, and sample bot messages.

Users may also unsubscribe from a bot. A user unsubscribing from a messaging bot may be a negative sign of the value of the messaging bot to subscribers, but a less drastic one than blocking. As such, it may be incorporated as a negative measure, but at a less negative weight than blocking. The bot framework component may receive a bot unsubscription command for the user account, the bot subscription command specifying the messaging bot and the messaging bot channel, and unsubscribe the user account from the messaging bot channel for the messaging bot in response to the bot unsubscription command. The bot framework component may record the bot unsubscription command in an unsubscribing history for a machine learning model.

2E illustrates an embodiment of a broadcast message in a consumer-to-business messaging system 250.

The bot framework component may receive a broadcast message from the messaging bot, the broadcast message specifying a broadcast channel. The bot framework component may assign the distribution of the broadcast message to a broadcast component.

A broadcast server may comprise a broadcast component. The broadcast component may receive a broadcast message from a messaging bot and determine a plurality of subscriber threads for the broadcast message. Determining the plurality of subscriber threads may be based on the messaging bot, such as by comparing a messaging bot identifier for the messaging bot to the subscription registry to retrieve the thread identifiers for the message threads subscribed to the messaging bot.

The broadcast component may add the broadcast message to a message queue for the user account when the messaging bot channel matches the broadcast channel. A broadcast message may be associated with a messaging bot channel origination indicator so as to indicate the interest the user is subscribed to that resulted in their receiving the broadcast message. This indicator may be displayed in association with the display of the broadcast message on the client device.

In some cases, the distribution of a broadcast message may be restricted to a subset of the subscriber set for the messaging bot and the messaging bot channel. A broadcast message may be received in association with a broadcast message target specification. The broadcast component may determine whether the user account matches the broadcast message target specification and add the broadcast message to a message queue for the user account when the user account matches the broadcast message target specification. The broadcast message target specification may specify one or more of demographic information, location information, and interest information.

In some cases, broadcast messages may be restricted to those users that have recently engaged with the messaging bot. A broadcast message target specification may specify a messaging bot engagement recency, which may be measured based on the recency with which the user has opened the message thread with the messaging bot. The broadcast message may distributed to only those users that meet a messaging bot engagement recency specification. This may serve to reward users that engage with the messaging bot. This may serve to focus a bot message on the most active customers that may be most interested in receiving information from the messaging bot, such as a message tailored to highly-active customers. In some embodiments, other user engagement information may also be used to select users, such as users that have engaged with the messaging bot at a minimum specified rate within the recent past or other engagement measures.

In some cases, broadcast messages may be restricted to those users that have recently engaged with a business associated with the messaging bot. A broadcast message target specification may specify a web page engagement recency, which may be measured based on the recency with which the user has opened a web page associated with a business associated with the messaging bot. A web plugin may be embedded in the web page and used to track user visitation with the web page. The broadcast message may distributed to only those users that meet a web page engagement recency specification. This may provide similar benefits to messaging bot engagement recency while expanding those benefits to user engagement with other points of exposure for a business. Other measures of user engagement outside the messaging system may also be used to restrict access, such as a user's physical presence at a location associated with the business, such as a retail location. A user's physical presence at a location may be measured by, for instance, geolocation of a user's mobile device. These measures may be combined, such that a broadcast message target specification specifies that a broadcast message is for delivery to users meeting an engagement recency with any of one or more of messaging, web access, and physical presence.

### Exemplary Data Structures

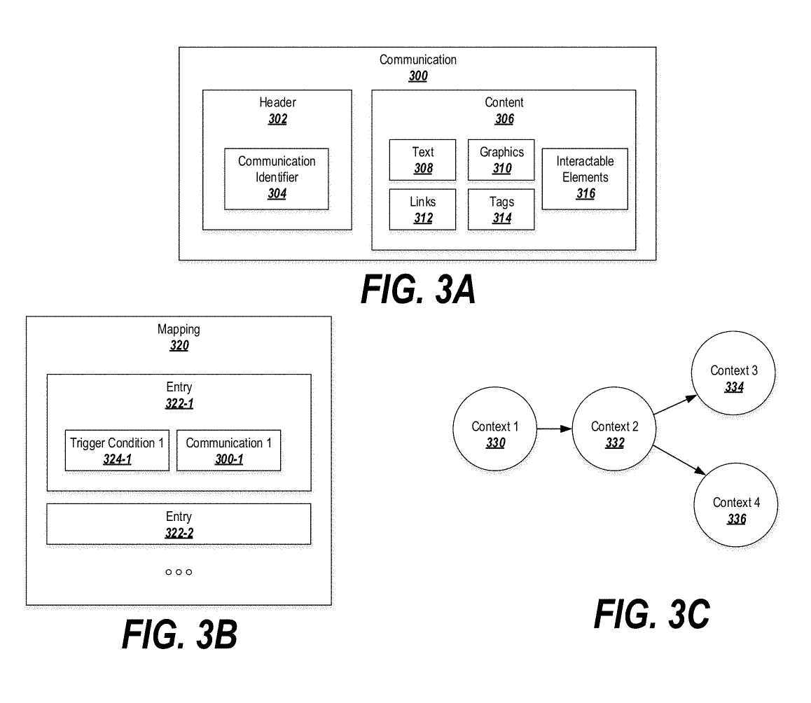

FIG. 3A depicts an exemplary message structure according to some embodiments. A communication 300 may include a communication or message used in a helper bot conversation. For example, the communication 300 may be or may be used to implement the second helper bot message 108 of the conversation 102 depicted in FIG. 1C. In exemplary embodiments, the communication 300 may be generated by the bot logic 218 and/or the messaging logic 212 depicted in FIG. 2A. For example, the communication 300 may be generated by the bot logic 218 and transmitted to the messaging server 210 for processing by the bot processing logic 214 to present a message associated with the communication 300 on the platform interface 100.

As shown in FIG. 3A, the communication 300 may include a header 302. In exemplary embodiments, the header 302 may include information used for processing the communication 300 (e.g., by messaging server 210 and/or bot processing logic 214), such as identifier information, processing information, etc. For example, the header 302 may include a communication identifier 304 that uniquely identifies the communication 300. In exemplary embodiments, the communication identifier 304 may include any symbol capable of uniquely identifying the communication 300, including an alphanumeric value, a binary value, etc. In various embodiments, the communication identifier 304 may encapsulate a context of the conversation. In some embodiments, the communication identifier 304 may be or may include metadata incorporated into the header 302. In some embodiments, the communication identifier 304 may serve as a link to a previous context of the conversation. In exemplary embodiments, a conversation may include a plurality of communications, including a first or starting communication. In some embodiments, the communication identifier may identify an intermediate communication after the starting communication to be used as a starting point when a triggering condition is encountered.

The communication 300 may include content 306 that may be presented to the user in the conversation. In exemplary embodiments, content 306 may include text 308, graphics 310, links 312, tags 314, interactable elements 316, etc. For example, text 308 may include alphanumeric characters displayed in a conversation message, such as the text “I noticed that you just created a new page” in the first helper bot message 104 of conversation 102 depicted in FIG. 1A. In another example, graphics 310 may include graphical images displayed within a conversation message, such as an image 110 used to provide a visual aid for the user to perform the step instructed in the second helper bot message 108 depicted in FIG. 1C. In some embodiments, the at least a portion of the content 306 may include the actual content (e.g., files, data, etc. for implementing the content on the platform interface 100). In some embodiments, at least a portion of the content 306 may include data representing a location to access the content for display on the platform interface 100 (e.g., pointers, links, etc. to content file locations).

FIG. 3B depicts an exemplary mapping structure suitable for use with some embodiments. A mapping structure 320 may include a data structure used to store data associated with trigger conditions and communications according to some embodiments. The mapping structure 320 may be configured to provide lookup functionality to determine whether a trigger condition has been initiated. In exemplary embodiments, the mapping structure 320 may include a database or other data storage construct having entries 322-i. An entry 322-i may include one or more trigger conditions 324-i and one or more communications 300-i. In some embodiments, each entry 322-i may be associated with one trigger condition 324-i and one communication 300-i. In some embodiments, each entry 322-i may be associated with a plurality of trigger conditions 324-i and a plurality of communications 300-i. In some embodiments, each entry 322-i may be or may be associated with a conversation (e.g., each trigger condition 324-i and communication 300-i of entry 322-1 may be associated with a conversation relating to creating a profile, uploading an image, modifying an advertisement, etc.).

In exemplary embodiments, the mapping structure 320 may be stored at and/or may be accessible to bot server 216 of FIG. 2A. The bot logic 218 of bot server 216 may receive a report of the status of an event triggered by the platform interface 100 as determined at messaging server 210. The status may be used to search the mapping structure to see if a trigger condition 324-i has occurred. For example, the status may be related to trigger condition 324-1 (creating a profile). The trigger condition 324-1 may be associated with communication 300-1. The bot logic may transmit communication 300-1 to messaging server 210 for presentation via the helper bot.

FIG. 3C depicts an exemplary context chain created based on message identifiers according to some embodiments. In exemplary embodiments, the context of a conversation may generally relate to what type of conversation is being carried out (e.g., page creation conversation, advertising campaign renewal conversation, etc.); which step of the conversation the user is currently engaged in; what previous actions were taken in furtherance of the goals of the conversation; whether the conversation is expired or still relevant; etc.

In exemplary embodiments, a conversation (such as conversation 102 of FIGS. 1A-1D) may flow from one context to another based on various factors, such as user interaction, preceding contexts, etc. For example, FIG. 3C may depict a conversation flow for creating a profile. The context 1 330 may include a first step for creating a profile, such automatically opening a settings page and the context 2 332 may include instructing the user to click on “create a new profile” on the settings page. In exemplary embodiments, each context 330-336 may be associated with a communication having a unique identifier. For example, a communication may include an identifier that serves as a link to a previous context of the conversation. In this manner, an order of the contexts 330-336 may be maintained based on the conditions or context of the process associated with the conversation (for instance, creating a user profile). Accordingly, if the conversation for creating a user profile is initiated when the user is already on the settings page, the conversation may begin at the context 332 (e.g., an intermediate communication or context) and not the context 330 because the user is already at the settings page.

In some embodiments, the contexts 330-336 may directly precede or follow another context 330-336. For example, the context 332 may always (or substantially always, barring error conditions, system settings, etc.) follows the context 330. In some embodiments, the contexts 330-336 may include branching contexts 330-336 determined based on certain conditions, such as triggering conditions. For example, the context 3 334 may be initiated if the user follows the instructions of the context 2 332 (e.g., create the profile, obtain information to populate profile, etc.). Alternatively, the context 4 336 may be initiated if the user does not follow the instructions of the context 332 (e.g., absence of selection of the “create a new profile” button after a threshold time period, negative or ambiguous user response, etc.). In another example, the user may be presented with the branching contexts 3 334 and 4 336 to provide different ways to proceed through the conversation. For example, the context 3 334 may be for creating a business profile, while the context 4 334 may be for creating a personal (i.e., non-business) profile.

### Exemplary Methods and Logic

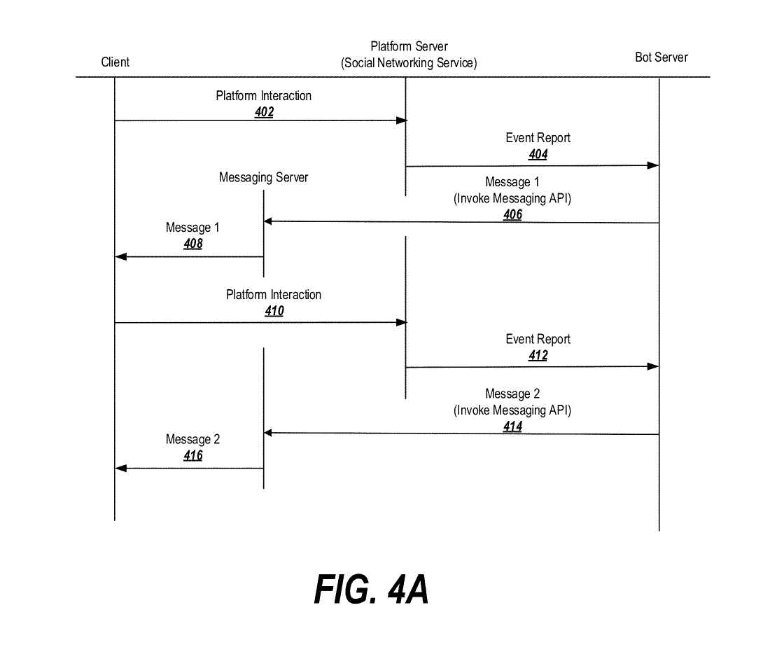

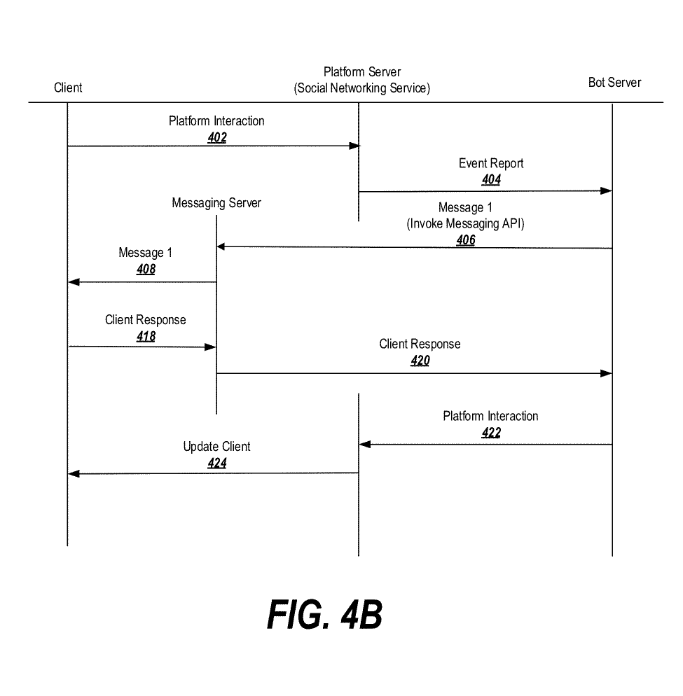

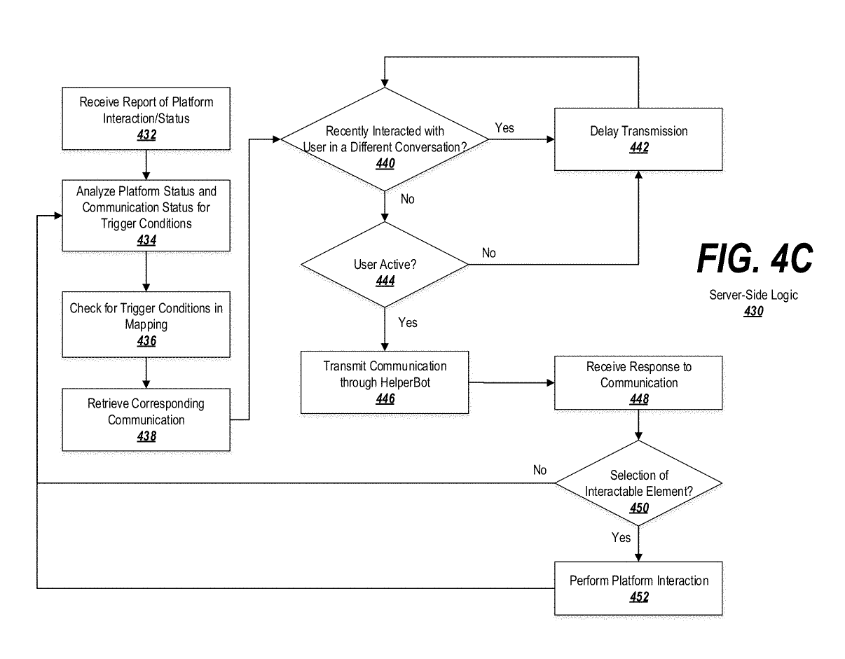

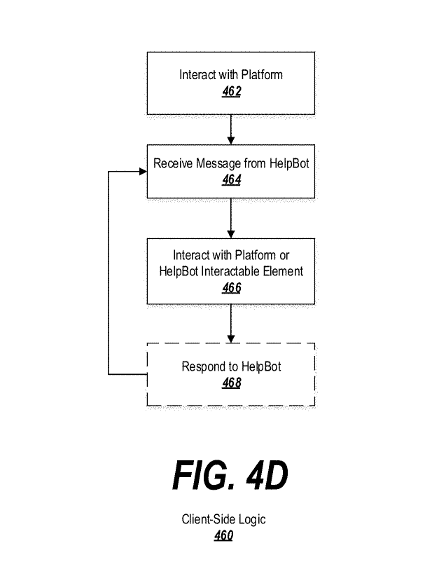

FIG. 4A is a data flow diagram depicting exemplary interactions between a client and a bot server, such as client 202, messaging (or platform) server 210, and bot server 216 of FIG. 2A.

A platform interaction may be performed by a user operating a social networking platform at a client. The client may provide a platform interaction message 402 to a platform server providing the social network service. The platform interaction message 402 may include data, information, or other signals indicating a platform interaction executed at the device on the social networking platform, such as selecting an object on a platform interface (e.g., creating a profile). In some embodiments, platform server may be, may include, or may be in communication with messaging server and vice versa. For example, platform server may manage the social networking service, while the messaging server may manage messaging associated with the social networking service (e.g., a messaging application of or associated with the social networking service).

The platform server may provide an event report 404 to the bot server. The event report may include a status indicating the platform interaction by the user at the social networking interface. The bot server may use the status to determine whether a triggering condition has occurred to initiate or continue a helper bot conversation. If a triggering condition has occurred, the bot server may determine a communication associated with the triggering condition. In exemplary embodiments, the event report 404 may be generated in real-time or substantially real-time following the platform interaction that triggered the platform interaction message 402. The bot server may transmit a message 1 406 to the messaging server that includes or is otherwise associated with the communication. For example, the message or communication may be transmitted as part of a messaging thread between the helper bot and a user associated with the user interaction. In exemplary embodiments, the message 1 406 may be operative to invoke a messaging API of messaging server, for example, to cause messaging server to transmit message 1 408 to client.

The client may receive the message 1 408, which may be displayed on a platform interface as part of a helper bot conversation. For example, the message 1 408 may provide instructions for creating a profile. The user may perform a platform interaction in response to the message 1 408, such as selecting an object on the platform interface to navigate to a page for creating a new profile or submitting a textual response. The response may be transmitted as a platform interaction 410 to the platform server. The platform server may provide a second event report 412 that has a status indicating the platform interaction 410 (e.g., navigating to a profile creation page).

The bot server may use the status of event report 412 to determine whether a triggering condition has occurred to continue the helper bot conversation. If a triggering condition has occurred, the bot server may determine a communication associated with the triggering condition (e.g., select a “create a new profile” button on the profile creation page). The bot server may transmit a message 2 414 to the messaging server that includes or is otherwise associated with the communication. The message 2 414 may be operative to invoke a messaging API of messaging server, for example, to cause messaging server to transmit message 2 416 to client. The client may receive the message 2 416, which may be displayed on the platform interface as part of the helper bot conversation. For example, the message 2 416 may provide instructions for creating a new profile following navigation to a create a profile page.

FIG. 4B is a data flow diagram depicting exemplary interactions between a client and a bot server, such as client 202, messaging (or platform) server 210, and bot server 216 of FIG. 2A.

A platform interaction may be performed by a user operating a social networking platform at a client. The client may provide a platform interaction message 402 to a platform server providing the social network service. The platform interaction message 402 may include data, information, or other signals indicating a platform interaction executed at the device on the social networking platform, such as selecting an object on a platform interface (e.g., creating a profile). In some embodiments, platform server may be, may include, or may be in communication with messaging server and vice versa. For example, platform server may manage the social networking service, while the messaging server may manage messaging associated with the social networking service (e.g., a messaging application of or associated with the social networking service).

The platform server may provide an event report 404 to the bot server. The event report may include a status indicating the platform interaction by the user at the social networking interface. The bot server may use the status to determine whether a triggering condition has occurred to initiate or continue a helper bot conversation. If a triggering condition has occurred, the bot server may determine a communication associated with the triggering condition. The bot server may transmit a message 1 406 to the messaging server that includes or is otherwise associated with the communication. In exemplary embodiments, the message 1 406 may be operative to invoke a messaging API of messaging server, for example, to cause messaging server to transmit message 1 408 to client.

Client may receive the message 1 408, which may be displayed on a platform interface as part of a helper bot conversation. For example, the message 1 408 may provide instructions for creating a profile. The user may perform a user interaction in response to the message 1 408, such as selecting an object on the platform interface to navigate to a page for creating a new profile or submitting a textual response. The response may be transmitted as a client response 418 to the messaging server. The messaging server may format the client response 418 into a form accessible by the bot server and transmitted as a client response 420 to the bot server.

The bot server may determine that a platform interaction should be initiated based on the client response. The bot server may look up the client response 420 in a status map to determine whether a triggering condition has occurred. For example, the message 1 408 may have asked the user whether they would like to create a user profile and the client response 420 may have been an affirmative response that the user would like to create the user profile. The bot server may determine that a triggering condition has occurred (e.g., user seeks to proceed with creating user profile) and that the communication associated with the triggering condition is the platform interaction of opening a “create a new profile” page. The bot server may transmit the platform interaction 422 to the platform server, for example, as instructions for the platform server to perform the platform interaction of opening the “create a new profile” page. The platform server may perform the action specified in the platform interaction 422 and may provide a update client 424 message to the client to update the navigation location of the platform interface being presented on the client to the “create a new profile” page.

FIGS. 4C-4D depict exemplary logic for carrying out the interactions described above. Although FIG. 4C describes exemplary operations as being performed on a server device (such as a bot server) and FIG. 4D describes exemplary operations as being performed on a client device (such as a personal computer, mobile device, etc.), it is understood that any of the described steps may be performed on either the client or the server, as appropriate.

FIG. 4C is a flowchart describing exemplary server-side logic 430 for providing a helper bot according to some embodiments. The logic 430 may be performed by a system, such as a server system running an application associated with a bot service for a computing platform, such as a messaging platform, a social networking platform, etc.

At block 432, the logic 430 may receive a report of platform interaction/status. The platform interaction/status may include user interaction with a platform interface, such as selection of a GUI object, a time-based event (e.g., expiration of a campaign), a message-based event (e.g., creating/receiving a message, post, comment, etc.), and/or the like. The platform interface may be operating on a client device (e.g., a social networking platform operating on a mobile device). A platform server (and/or a messaging server) may monitor (e.g., on a push or pull basis) for platform interactions at the client device. For example, the platform server may monitor for the receipt of status reports from the client device that indicate the platform interactions performed at platform interface at the client device.

The logic 430 may analyze the platform status and communication status for trigger conditions at block 434. The report may include various statuses, such as a platform status, a communication status, etc. The logic 430 may determine whether a status associated with the report is related to a triggering conditions, such as expiration of an ad campaign, creating a page without a corresponding user profile, receiving a social networking post, etc. At block 436, the logic 430 may check for trigger conditions in mapping 436. For example, a mapping structure may include entries that have a trigger condition associated with a communication. The logic 430 may determine whether the mapping structure includes a trigger condition that matches the trigger condition associated with the report. At block 438, the logic 430 may retrieve a communication corresponding to the trigger condition matching the status in the mapping structure. The communication may be stored in or otherwise accessible by the bot server. In some embodiments, the communication may include preformed or template communications that may be assembled on an as-needed basis (for instance, with text values, file locations, etc. specified when needed).

In exemplary embodiments, the logic 430 may determine whether there are any delay conditions to delay communication with the user associated with the report. For example, at block 440, the logic 430 may determine whether a helper bot has recently interacted with the user in a different conversation (e.g., a conversation not related to the report received at block 432). If the helper bot has recently interacted with the user in a different conversation, the logic 430 may delay transmission at block 442 (e.g., for a threshold amount of time). If the helper bot has not recently interacted with the user in a different conversation, the logic 430 may determine whether the user is active at block 444. If the user is not active, the logic 430 may delay transmission at block 442. If the user is active, the logic 430 may transmit the communication through the helper bot at block 446. For example, the helper bot may display the communication (e.g., text, images, interactive elements, etc.) in a conversation on the platform interface.

At block 448, the logic 430 may receive a response to the communication. In some embodiments, the communication may include an interactable element, such as a button, check box, etc. that may be selected by the user directly within the helper bot conversation. In such embodiments, the response may be generated by the user interacting (e.g., selecting) the interactable element. In some embodiments, the user may generate a response through performing a platform interaction at the platform interface (i.e., that does not involve an interactable element), such as directly within the helper bot conversation (e.g., entering text) and/or by performing an action (such as selecting a button, navigating to a page, etc.). In some embodiments, the response may be in the form of a report, such as the response received by the logic 430 at block 432.

The logic 430 may determine whether the response was initiated via an interactable element at block 450. If the response was initiated via an interactable element, the logic 430 may perform the platform interaction associated with the interactable element (e.g., opening a page) at block 452 and proceed to analyze the response at block 434. If the response was not initiated via an interactable element, the logic 430 may proceed to analyze the response at block 434.

FIG. 4D is a flowchart describing exemplary client-side logic 460 for interacting with a helper bot according to some embodiments. The logic 460 may be performed by a system, such as a client computing system (e.g., a mobile computing device) operating a platform interface for a platform, such as a messaging platform, a social networking platform, etc.

At block 462, the logic 460 may interact with a platform. For example, logic 460 may interact with a platform being provided via a client application operating on a client device in response to user input received at the client device. The user input may be selection of a platform interface object, such as a button to create a profile on the platform. The logic 460 may receive a message from a helper bot at block 464. For example, the platform interaction may have triggered the transmission of a report to a bot server providing a bot service for the platform. The report may have included a status indicating the particular platform interaction, which may be a triggering condition for a helper bot (e.g., a helper bot to assist a user to create a profile on the platform). The bot server may initiate or continue a conversation via the helper bot on the platform interface being displayed on the client device. For example, a conversation with the message “First, click on the gear icon in the upper right corner of the screen to open the settings menu” may be presented to the user.

At block 466, the logic 460 may interact with the platform or a helper bot interactable element via user input received at the client device. For example, in response to the message received at block 464, the user may respond by entering an “OK, I'm there” message in the helper bot conversation. In another example, the message received at block 464 may include an interactable element that may be selected by the user to following the instructions provided by the helper bot (e.g., select the interactable element to proceed and open the settings menu).

The logic 460 may include the optional block 468 for responding to the helper bot. For example, if the user performs an action that does not require responding directly to the helper bot, then the logic 460 does not perform the option block 468. For instance, if the helper bot receives a report that the user has navigated directly to the settings page or the user uses an interactable element and the helper bot takes the user to the settings page, the logic 460 does not need to communicate to the helper bot that the settings page is open. In the alternative, if the user responds in a manner such that the helper bot may not know the status of the user or platform interface, such as the user entering an “OK, I'm there” message in the helper bot conversation, then the logic may provide a response to the helper bot at block 468 so that the helper bot may process the platform interaction.

In this case, conversation logic may take into account the previous context (associated with identifier “2”) and the user's response, and may move on to the next step in the conversation. Alternatively, if the user says “I'm lost” or “I'm at the status update page,” the logic may trigger a different message that attempts to explain how to get to the settings menu more descriptively.

The above examples may be implemented by a messaging system that is provided either locally, at a client device, or remotely (e.g., at a remote server). FIGS. 5A-5C depict various examples of messaging systems, and are discussed in more detail below.

### Messaging System Overview

FIG. 5A depicts an exemplary centralized messaging system 500, in which functionality for organizing messages asynchronously and/or using threads is integrated into a messaging server. The centralized system 500 may implement some or all of the structure and/or operations of a messaging service in a single computing entity, such as entirely within a single centralized server device 526.

The messaging system 500 may include a computer-implemented system having software applications that include one or more components. Although the messaging system 500 shown in FIG. 5A has a limited number of elements in a certain topology, the messaging system 500 may include more or fewer elements in alternate topologies.

A messaging service 500 may be generally arranged to receive, store, and deliver messages. The messaging service 500 may store messages while messaging clients 520, such as may execute on client devices 510, are offline and deliver the messages once the messaging clients are available.

A client device 510 may transmit messages addressed to a recipient user, user account, or other identifier resolving to a receiving client device 510.In exemplary embodiments, each of the client devices 510 and their respective messaging clients 520 are associated with a particular user or users of the messaging service 500. In some embodiments, the client devices 510 may be cellular devices such as smartphones and may be identified to the messaging service 500 based on a phone number associated with each of the client devices 510. In some embodiments, each messaging client may be associated with a user account registered with the messaging service 500. In general, each messaging client may be addressed through various techniques for the reception of messages. While in some embodiments the client devices 510 may be cellular devices, in other embodiments one or more of the client devices 510 may be personal computers, tablet devices, any other form of computing device.

The client 510 may include one or more input devices 512 and one or more output devices 518. The input devices 512 may include, for example, microphones, keyboards, cameras, electronic pens, touch screens, and other devices for receiving inputs including message data, requests, commands, user interface interactions, selections, and other types of input. The output devices 518 may include a speaker, a display device such as a monitor or touch screen, and other devices for presenting an interface to the messaging system 500.

The client 510 may include a memory 519, which may be a non-transitory computer readable storage medium, such as one or a combination of a hard drive, solid state drive, flash storage, read only memory, or random access memory. The memory 519 may a representation of an input 514 and/or a representation of an output 516, as well as one or more applications. For example, the memory 519 may store a messaging client 520 and/or a social networking client that allows a user to interact with a social networking service.

The input 514 may be textual, such as in the case where the input device 212 is a keyboard. Alternatively, the input 514 may be an audio recording, such as in the case where the input device 512 is a microphone. Accordingly, the input 514 may be subjected to automatic speech recognition (ASR) logic in order to transform the audio recording to text that is processable by the messaging system 500. The ASR logic may be located at the client device 510 (so that the audio recording is processed locally by the client 510 and corresponding text is transmitted to the messaging server 526), or may be located remotely at the messaging server 526 (in which case, the audio recording may be transmitted to the messaging server 526 and the messaging server 526 may process the audio into text). Other combinations are also possible—for example, if the input device 512 is a touch pad or electronic pen, the input 514 may be in the form of handwriting, which may be subjected to handwriting or optical character recognition analysis logic in order to transform the input 512 into processable text.

The client 510 may be provided with a network interface 522 for communicating with a network 524, such as the Internet. The network interface 522 may transmit the input 512 in a format and/or using a protocol compatible with the network 524 and may receive a corresponding output 516 from the network 524.

The network interface 522 may communicate through the network 524 to a messaging server 526. The messaging server 526 may be operative to receive, store, and forward messages between messaging clients.

The messaging server 526 may include a network interface 522, messaging preferences 528, and communications logic 530. The messaging preferences 528 may include one or more privacy settings or other preferences for one or more users and/or message threads. Furthermore, the messaging preferences 528 may include one or more settings, including default settings, for the logic described herein.

The communications logic 530 may include logic for implementing any or all of the above-described features of the present invention. Alternatively or in addition, some or all of the features may be implemented at the client 510-i, such as by being incorporated into an application such as the messaging client 520.

The network interface 522 of the client 510 and/or the messaging server 526 may also be used to communicate through the network 524 with an app server 540. The app server may store software or applications in an app library 544, representing software available for download by the client 510-i and/or the messaging server 526 (among other entities). An app in the app library 544 may fully or partially implement the embodiments described herein. Upon receiving a request to download software incorporating exemplary embodiments, app logic 542 may identify a corresponding app in the app library 544 and may provide (e.g., via a network interface) the app to the entity that requested the software.

The network interface 522 of the client 510 and/or the messaging server 526 may also be used to communicate through the network 524 with a social networking server 536. The social networking server 536 may include or may interact with a social networking graph 538 that defines connections in a social network. Furthermore, the messaging server 526 may connect to the social networking server 536 for various purposes, such as retrieving connection information, messaging history, event details, etc. from the social network.

A user of the client 510 may be an individual (human user), an entity (e.g., an enterprise, business, or third-party application), or a group (e.g., of individuals or entities) that interacts or communicates with or over the social networking server 536. The social-networking server 536 may be a network-addressable computing system hosting an online social network. The social networking server 536 may generate, store, receive, and send social-networking data, such as, for example, user-profile data, concept-profile data, social-graph information, or other suitable data related to the online social network. The social networking server 536 may be accessed by the other components of the network environment either directly or via the network 524.

The social networking server 536 may include an authorization server (or other suitable component(s)) that allows users to opt in to or opt out of having their actions logged by social-networking server 536 or shared with other systems (e.g., third-party systems, such as the messaging server 526), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking server 536 through blocking, data hashing, anonymization, or other suitable techniques as appropriate.

More specifically, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums).

In particular embodiments, privacy settings may be associated with particular elements of the social networking graph 538. Privacy settings of a social-graph element, such as a node or an edge, may specify how the social-graph element, information associated with the social-graph element, or content objects associated with the social-graph element can be accessed using the online social network. As an example and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by social networking server 536 or shared with other systems. In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In response to a request from a user (or other entity) for a particular object stored in a data store, the social networking server 536 may send a request to the data store for the object. The request may identify the user associated with the request. The requested data object may only be sent to the user (or a client system 510 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results.

In some embodiments, targeting criteria may be used to identify users of the social network for various purposes. Targeting criteria used to identify and target users may include explicit, stated user interests on social-networking server 536 or explicit connections of a user to a node, object, entity, brand, or page on social networking server 536. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also implicate privacy settings (such as user opt-outs), data hashing, or data anonymization, as appropriate.

The centralized embodiment depicted in FIG. 5A may be well-suited to deployment as a new system or as an upgrade to an existing system, because the logic for implementing exemplary embodiments is incorporated into the messaging server 526. In contrast, FIG. 5B depicts an exemplary distributed messaging system 550, in which functionality for implementing exemplary embodiments is distributed and remotely accessible from the messaging server. Examples of a distributed system 550 include a client-server architecture, a 3-tier architecture, an N-tier architecture, a tightly-coupled or clustered architecture, a peer-to-peer architecture, a master-slave architecture, a shared database architecture, and other types of distributed systems.

Many of the components depicted in FIG. 5B are identical to those in FIG. 5A, and a description of these elements is not repeated here for the sake of brevity (the app server 540 is omitted from the Figure for ease of discussion, although it is understood that this embodiment may also employ an app server 540). The primary difference between the centralized embodiment and the distributed embodiment is the addition of a separate bot processing server 552, which hosts the logic 530 for implementing exemplary embodiments. The bot processing server 552 may be distinct from the messaging server 526 but may communicate with the messaging server 526, either directly or through the network 524, to provide the functionality of the logic 530 and the logic 534 to the messaging server 526.

The embodiment depicted in FIG. 5B may be particularly well suited to allow exemplary embodiments to be deployed alongside existing messaging systems, for example when it is difficult or undesirable to replace an existing messaging server. Additionally, in some cases the messaging server 526 may have limited resources (e.g. processing or memory resources) that limit or preclude the addition of the additional pivot functionality. In such situations, the capabilities described herein may still be provided through the separate bot processing server 552.

In still further embodiments, the logic 532 may be provided locally at the client 510-i, for example as part of the messaging client 520. In these embodiments, each client 510-i makes its own determination as to which messages belong to which thread, and how to update the display and issue notifications. As a result, different clients 510-i may display the same conversation differently, depending on local settings (for example, the same messages may be assigned to different threads, or similar threads may have different parents or highlights).

FIG. 5C illustrates an example of a social networking graph 538. In exemplary embodiments, a social networking service may store one or more social graphs 538 in one or more data stores as a social graph data structure via the social networking service.

The social graph 538 may include multiple nodes, such as user nodes 554 and concept nodes 556. The social graph 228 may furthermore include edges 558 connecting the nodes. The nodes and edges of social graph 228 may be stored as data objects, for example, in a data store (such as a social-graph database). Such a data store may include one or more searchable or queryable indexes of nodes or edges of social graph 228.

The social graph 538 may be accessed by a social-networking server 226, client system 210, third-party system (e.g., the translation server 224), or any other approved system or device for suitable applications.

A user node 554 may correspond to a user of the social-networking system. A user may be an individual (human user), an entity (e.g., an enterprise, business, or third-party application), or a group (e.g., of individuals or entities) that interacts or communicates with or over the social-networking system. In exemplary embodiments, when a user registers for an account with the social-networking system, the social-networking system may create a user node 554 corresponding to the user, and store the user node 30 in one or more data stores. Users and user nodes 554 described herein may, where appropriate, refer to registered users and user nodes 554 associated with registered users. In addition or as an alternative, users and user nodes 554 described herein may, where appropriate, refer to users that have not registered with the social-networking system. In particular embodiments, a user node 554 may be associated with information provided by a user or information gathered by various systems, including the social-networking system. As an example and not by way of limitation, a user may provide their name, profile picture, contact information, birth date, sex, marital status, family status, employment, education background, preferences, interests, or other demographic information. In particular embodiments, a user node 554 may be associated with one or more data objects corresponding to information associated with a user. In particular embodiments, a user node 554 may correspond to one or more webpages. A user node 554 may be associated with a unique user identifier for the user in the social-networking system.

In particular embodiments, a concept node 556 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking system or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 556 may be associated with information of a concept provided by a user or information gathered by various systems, including the social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 556 may be associated with one or more data objects corresponding to information associated with concept node 556. In particular embodiments, a concept node 556 may correspond to one or more webpages.

In particular embodiments, a node in social graph 538 may represent or be represented by a webpage (which may be referred to as a “profile page”). Profile pages may be hosted by or accessible to the social-networking system. Profile pages may also be hosted on third-party websites associated with a third-party server. As an example and not by way of limitation, a profile page corresponding to a particular external webpage may be the particular external webpage and the profile page may correspond to a particular concept node 556. Profile pages may be viewable by all or a selected subset of other users. As an example and not by way of limitation, a user node 554 may have a corresponding user-profile page in which the corresponding user may add content, make declarations, or otherwise express himself or herself. A business page such as business page 205 may comprise a user-profile page for a commerce entity. As another example and not by way of limitation, a concept node 556 may have a corresponding concept-profile page in which one or more users may add content, make declarations, or express themselves, particularly in relation to the concept corresponding to concept node 556.

In particular embodiments, a concept node 556 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system a message indicating the user's action. In response to the message, the social-networking system may create an edge (e.g., an “eat” edge) between a user node 554 corresponding to the user and a concept node 556 corresponding to the third-party webpage or resource and store edge 558 in one or more data stores.

In particular embodiments, a pair of nodes in social graph 538 may be connected to each other by one or more edges 558. An edge 558 connecting a pair of nodes may represent a relationship between the pair of nodes. In particular embodiments, an edge 558 may include or represent one or more data objects or attributes corresponding to the relationship between a pair of nodes. As an example and not by way of limitation, a first user may indicate that a second user is a “friend” of the first user. In response to this indication, the social-networking system may send a “friend request” to the second user. If the second user confirms the “friend request,” the social-networking system may create an edge 558 connecting the first user's user node 554 to the second user's user node 554 in social graph 538 and store edge 558 as social-graph information in one or more data stores. In the example of FIG. 5C, social graph 538 includes an edge 558 indicating a friend relation between user nodes 554 of user “Amanda” and user “Dorothy.” Although this disclosure describes or illustrates particular edges 558 with particular attributes connecting particular user nodes 554, this disclosure contemplates any suitable edges 558 with any suitable attributes connecting user nodes 554. As an example and not by way of limitation, an edge 558 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 538 by one or more edges 558.

In particular embodiments, an edge 558 between a user node 554 and a concept node 556 may represent a particular action or activity performed by a user associated with user node 554 toward a concept associated with a concept node 556. As an example and not by way of limitation, as illustrated in FIG. 5C, a user may “like,” “attended,” “played,” “listened,” “cooked,” “worked at,” or “watched” a concept, each of which may correspond to a edge type or subtype. A concept-profile page corresponding to a concept node 556 may include, for example, a selectable “check in” icon (such as, for example, a clickable “check in” icon) or a selectable “add to favorites” icon. Similarly, after a user clicks these icons, the social-networking system may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking system may create a “listened” edge 558 and a “used” edge (as illustrated in FIG. 5C) between user nodes 554 corresponding to the user and concept nodes 556 corresponding to the song and application to indicate that the user listened to the song and used the application. Moreover, the social-networking system may create a “played” edge 558 (as illustrated in FIG. 5C) between concept nodes 556 corresponding to the song and the application to indicate that the particular song was played by the particular application. In this case, “played” edge 558 corresponds to an action performed by an external application (SPOTIFY) on an external audio file (the song “Across the Sea”). Although this disclosure describes particular edges 558 with particular attributes connecting user nodes 554 and concept nodes 556, this disclosure contemplates any suitable edges 558 with any suitable attributes connecting user nodes 554 and concept nodes 556. Moreover, although this disclosure describes edges between a user node 554 and a concept node 556 representing a single relationship, this disclosure contemplates edges between a user node 554 and a concept node 556 representing one or more relationships. As an example and not by way of limitation, an edge 558 may represent both that a user likes and has used at a particular concept. Alternatively, another edge 558 may represent each type of relationship (or multiples of a single relationship) between a user node 554 and a concept node 556 (as illustrated in FIG. 5C between user node 554 for user “Edwin” and concept node 556 for “SPOTIFY”).

In particular embodiments, the social-networking system may create an edge 558 between a user node 554 and a concept node 556 in social graph 538. As an example and not by way of limitation, a user viewing a concept-profile page (such as, for example, by using a web browser or a special-purpose application hosted by the user's client system) may indicate that he or she likes the concept represented by the concept node 556 by clicking or selecting a “Like” icon, which may cause the user's client system to send to the social-networking system a message indicating the user's liking of the concept associated with the concept-profile page. In response to the message, the social-networking system may create an edge 558 between user node 554 associated with the user and concept node 556, as illustrated by “like” edge 558 between the user and concept node 556. In particular embodiments, the social-networking system may store an edge 558 in one or more data stores. In particular embodiments, an edge 558 may be automatically formed by the social-networking system in response to a particular user action. As an example and not by way of limitation, if a first user uploads a picture, watches a movie, or listens to a song, an edge 558 may be formed between user node 554 corresponding to the first user and concept nodes 556 corresponding to those concepts. Although this disclosure describes forming particular edges 558 in particular manners, this disclosure contemplates forming any suitable edges 558 in any suitable manner.

The social graph 538 may further comprise a plurality of product nodes. Product nodes may represent particular products that may be associated with a particular business. A business may provide a product catalog to a consumer-to-business service and the consumer-to-business service may therefore represent each of the products within the product in the social graph 538 with each product being in a distinct product node. A product node may comprise information relating to the product, such as pricing information, descriptive information, manufacturer information, availability information, and other relevant information. For example, each of the items on a menu for a restaurant may be represented within the social graph 538 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 538. The information for a product node may be manipulated by the social-networking system as a product object that encapsulates information regarding the referenced product.

As such, the social graph 538 may be used to infer shared interests, shared experiences, or other shared or common attributes of two or more users of a social-networking system. For instance, two or more users each having an edge to a common business, product, media item, institution, or other entity represented in the social graph 538 may indicate a shared relationship with that entity, which may be used to suggest customization of a use of a social-networking system, including a messaging system, for one or more users.

### Messaging Architecture

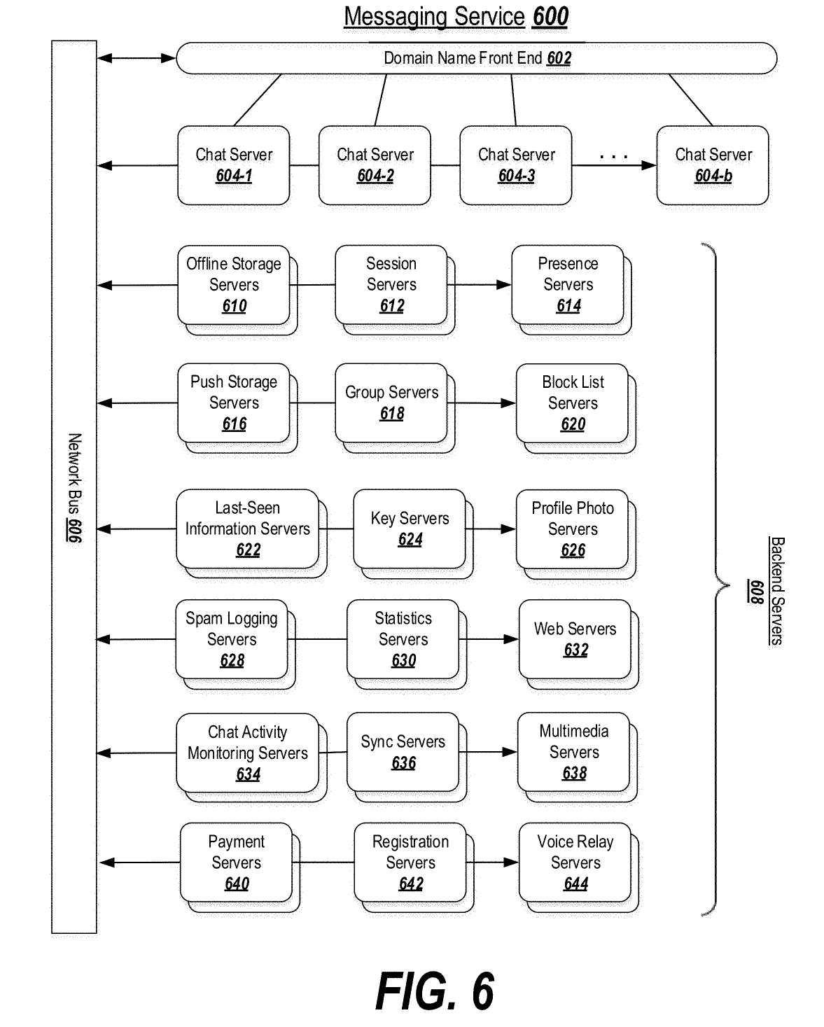

FIG. 6 illustrates an embodiment of a plurality of servers implementing various functions of a messaging service 600. It will be appreciated that different distributions of work and functions may be used in various embodiments of a messaging service 600.

The messaging service 600 may comprise a domain name front end 602. The domain name front end 602 may be assigned one or more domain names associated with the messaging service 600 in a domain name system (DNS). The domain name front end 602 may receive incoming connections and distribute the connections to servers providing various messaging services.

The messaging service 602 may comprise one or more chat servers 604. The chat servers 604 may comprise front-end servers for receiving and transmitting user-to-user messaging updates such as chat messages. Incoming connections may be assigned to the chat servers 604 by the domain name front end 602 based on workload balancing.

The messaging service 600 may comprise backend servers 608. The backend servers 608 may perform specialized tasks in the support of the chat operations of the front-end chat servers 604. A plurality of different types of backend servers 608 may be used. It will be appreciated that the assignment of types of tasks to different backend serves 608 may vary in different embodiments. In some embodiments some of the back-end services provided by dedicated servers may be combined onto a single server or a set of servers each performing multiple tasks divided between different servers in the embodiment described herein. Similarly, in some embodiments tasks of some of dedicated back-end servers described herein may be divided between different servers of different server groups.

The messaging service 600 may comprise one or more offline storage servers 610. The one or more offline storage servers 610 may store messaging content for currently-offline messaging clients in hold for when the messaging clients reconnect.

The messaging service 600 may comprise one or more sessions servers 612. The one or more session servers 612 may maintain session state of connected messaging clients.

The messaging service 600 may comprise one or more presence servers 614. The one or more presence servers 614 may maintain presence information for the messaging service 600. Presence information may correspond to user-specific information indicating whether or not a given user has an online messaging client and is available for chatting, has an online messaging client but is currently away from it, does not have an online messaging client, and any other presence state.

The messaging service 600 may comprise one or more push storage servers 616. The one or more push storage servers 616 may cache push requests and transmit the push requests to messaging clients. Push requests may be used to wake messaging clients, to notify messaging clients that a messaging update is available, and to otherwise perform server-side-driven interactions with messaging clients.

The messaging service 600 may comprise one or more group servers 618. The one or more group servers 618 may maintain lists of groups, add users to groups, remove users from groups, and perform the reception, caching, and forwarding of group chat messages.

The messaging service 600 may comprise one or more block list servers 620. The one or more block list servers 620 may maintain user-specific block lists, the user-specific incoming-block lists indicating for each user the one or more other users that are forbidden from transmitting messages to that user. Alternatively or additionally, the one or more block list servers 620 may maintain user-specific outgoing-block lists indicating for each user the one or more other users that that user is forbidden from transmitting messages to. It will be appreciated that incoming-block lists and outgoing-block lists may be stored in combination in, for example, a database, with the incoming-block lists and outgoing-block lists representing different views of a same repository of block information.

The messaging service 600 may comprise one or more last seen information servers 622. The one or more last seen information servers 622 may receive, store, and maintain information indicating the last seen location, status, messaging client, and other elements of a user's last seen connection to the messaging service 600.

The messaging service 600 may comprise one or more key servers 624. The one or more key servers may host public keys for public/private key encrypted communication.

The messaging service 600 may comprise one or more profile photo servers 626. The one or more profile photo servers 626 may store and make available for retrieval profile photos for the plurality of users of the messaging service 600.

The messaging service 600 may comprise one or more spam logging servers 628. The one or more spam logging servers 628 may log known and suspected spam (e.g., unwanted messages, particularly those of a promotional nature). The one or more spam logging servers 628 may be operative to analyze messages to determine whether they are spam and to perform punitive measures, in some embodiments, against suspected spammers (users that send spam messages).

The messaging service 600 may comprise one or more statistics servers 630. The one or more statistics servers may compile and store statistics information related to the operation of the messaging service 600 and the behavior of the users of the messaging service 600.

The messaging service 600 may comprise one or more web servers 632. The one or more web servers 632 may engage in hypertext transport protocol (HTTP) and hypertext transport protocol secure (HTTPS) connections with web browsers.

The messaging service 600 may comprise one or more chat activity monitoring servers 634. The one or more chat activity monitoring servers 634 may monitor the chats of users to determine unauthorized or discouraged behavior by the users of the messaging service 600. The one or more chat activity monitoring servers 634 may work in cooperation with the spam logging servers 628 and block list servers 620, with the one or more chat activity monitoring servers 634 identifying spam or other discouraged behavior and providing spam information to the spam logging servers 628 and blocking information, where appropriate to the block list servers 620.

The messaging service 600 may comprise one or more sync servers 636. The one or more sync servers 636 may sync the communication system 500 with contact information from a messaging client, such as an address book on a mobile phone, to determine contacts for a user in the messaging service 600.

The messaging service 600 may comprise one or more multimedia servers 638. The one or more multimedia servers may store multimedia (e.g., images, video, audio) in transit between messaging clients, multimedia cached for offline endpoints, and may perform transcoding of multimedia.

The messaging service 600 may comprise one or more payment servers 640. The one or more payment servers 640 may process payments from users. The one or more payment servers 640 may connect to external third-party servers for the performance of payments.

The messaging service 600 may comprise one or more registration servers 642. The one or more registration servers 642 may register new users of the messaging service 600.

The messaging service 600 may comprise one or more voice relay servers 644. The one or more voice relay servers 644 may relay voice-over-Internet-protocol (VoIP) voice communication between messaging clients for the performance of VoIP calls.

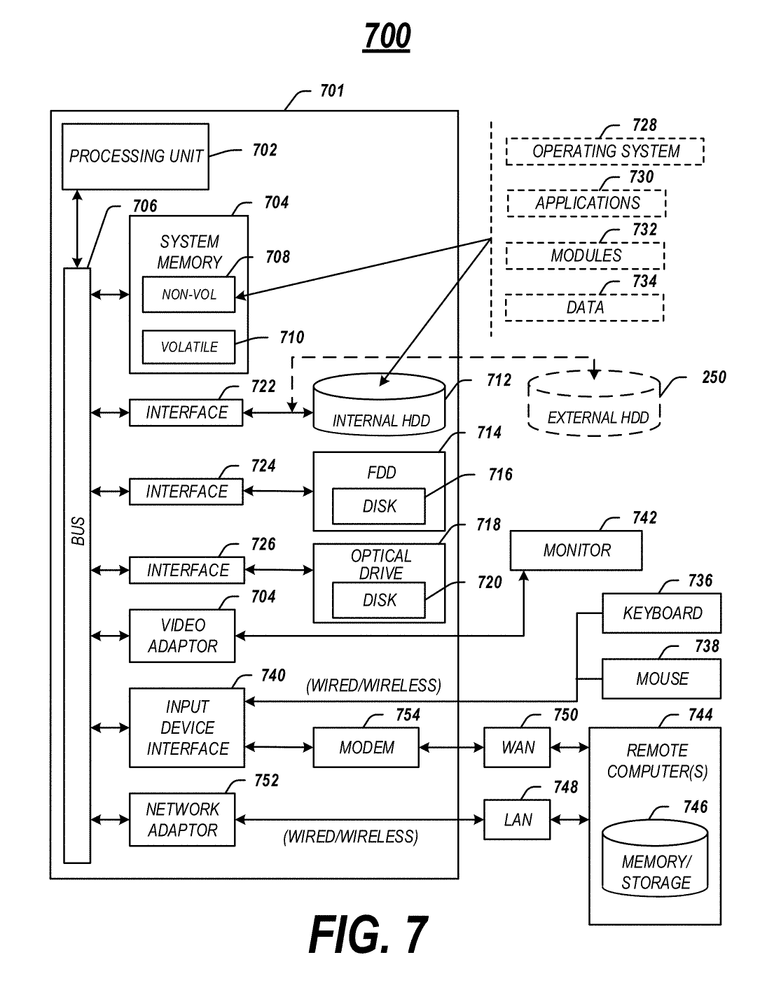

The above-described methods may be embodied as instructions on a computer readable medium or as part of a computing architecture. FIG. 7 illustrates an embodiment of an exemplary computing architecture 700 suitable for implementing various embodiments as previously described. In one embodiment, the computing architecture 700 may comprise or be implemented as part of an electronic device, such as a computer 701. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 702, a system memory 704 and a system bus 706. The processing unit 702 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 702.

The system bus 706 provides an interface for system components including, but not limited to, the system memory 704 to the processing unit 702. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile memory 708 and/or volatile memory 710. A basic input/output system (BIOS) can be stored in the non-volatile memory 708.

The computing architecture 700 may include various types of computer-readable storage media in the form of one or more lower speed memory units, including an internal (or external) hard disk drive (HDD) 712, a magnetic floppy disk drive (FDD) 714 to read from or write to a removable magnetic disk 716, and an optical disk drive 718 to read from or write to a removable optical disk 720 (e.g., a CD-ROM or DVD). The HDD 712, FDD 714 and optical disk drive 720 can be connected to the system bus 706 by an HDD interface 722, an FDD interface 724 and an optical drive interface 726, respectively. The HDD interface 722 for external drive implementations can include at least one or both of Universal Serial Bus (USB) and IEEE 694 interface technologies.

The drives and associated computer-readable media provide volatile and/or nonvolatile storage of data, data structures, computer-executable instructions, and so forth. For example, a number of program modules can be stored in the drives and memory units 708, 712, including an operating system 728, one or more application programs 730, other program modules 732, and program data 734. In one embodiment, the one or more application programs 730, other program modules 732, and program data 734 can include, for example, the various applications and/or components of the communication system 500.

A user can enter commands and information into the computer 701 through one or more wire/wireless input devices, for example, a keyboard 736 and a pointing device, such as a mouse 738. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 702 through an input device interface 740 that is coupled to the system bus 706, but can be connected by other interfaces such as a parallel port, IEEE 694 serial port, a game port, a USB port, an IR interface, and so forth.

A monitor 742 or other type of display device is also connected to the system bus 706 via an interface, such as a video adaptor 744. The monitor 742 may be internal or external to the computer 701. In addition to the monitor 742, a computer typically includes other peripheral output devices, such as speakers, printers, and so forth.

The computer 701 may operate in a networked environment using logical connections via wire and/or wireless communications to one or more remote computers, such as a remote computer 744. The remote computer 744 can be a workstation, a server computer, a router, a personal computer, portable computer, microprocessor-based entertainment appliance, a peer device or other common network node, and typically includes many or all of the elements described relative to the computer 701, although, for purposes of brevity, only a memory/storage device 746 is illustrated. The logical connections depicted include wire/wireless connectivity to a local area network (LAN) 748 and/or larger networks, for example, a wide area network (WAN) 750. Such LAN and WAN networking environments are commonplace in offices and companies, and facilitate enterprise-wide computer networks, such as intranets, all of which may connect to a global communications network, for example, the Internet.

When used in a LAN networking environment, the computer 701 is connected to the LAN 748 through a wire and/or wireless communication network interface or adaptor 752. The adaptor 752 can facilitate wire and/or wireless communications to the LAN 748, which may also include a wireless access point disposed thereon for communicating with the wireless functionality of the adaptor 752.

When used in a WAN networking environment, the computer 701 can include a modem 754, or is connected to a communications server on the WAN 750, or has other means for establishing communications over the WAN 750, such as by way of the Internet. The modem 754, which can be internal or external and a wire and/or wireless device, connects to the system bus 706 via the input device interface 740. In a networked environment, program modules depicted relative to the computer 701, or portions thereof, can be stored in the remote memory/storage device 746. It will be appreciated that the network connections shown are exemplary and other means of establishing a communications link between the computers can be used.

The computer 701 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

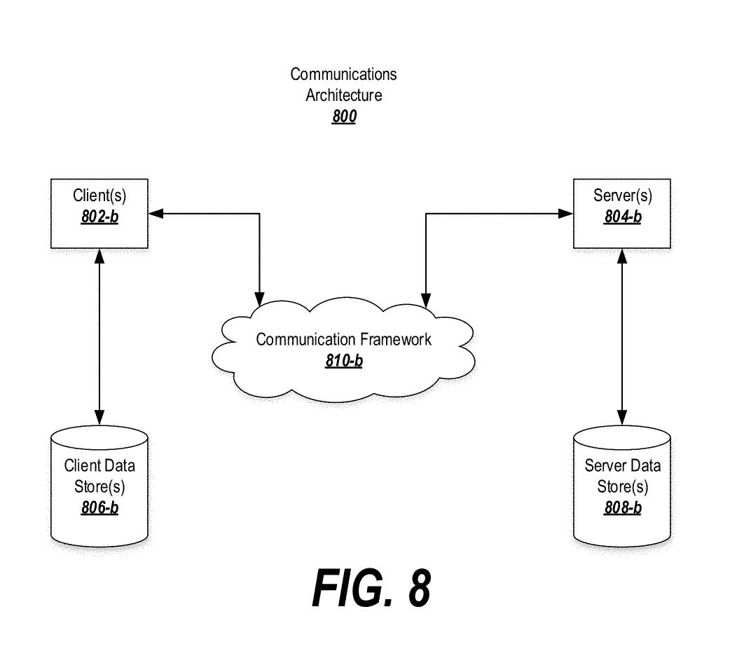

FIG. 8 is a block diagram depicting an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The clients 802 may implement the client device 510. The servers 804 may implement the server device 526. The clients 802 and the servers 804 are operatively connected to one or more respective client data stores 806 and server data stores 808 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.8a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

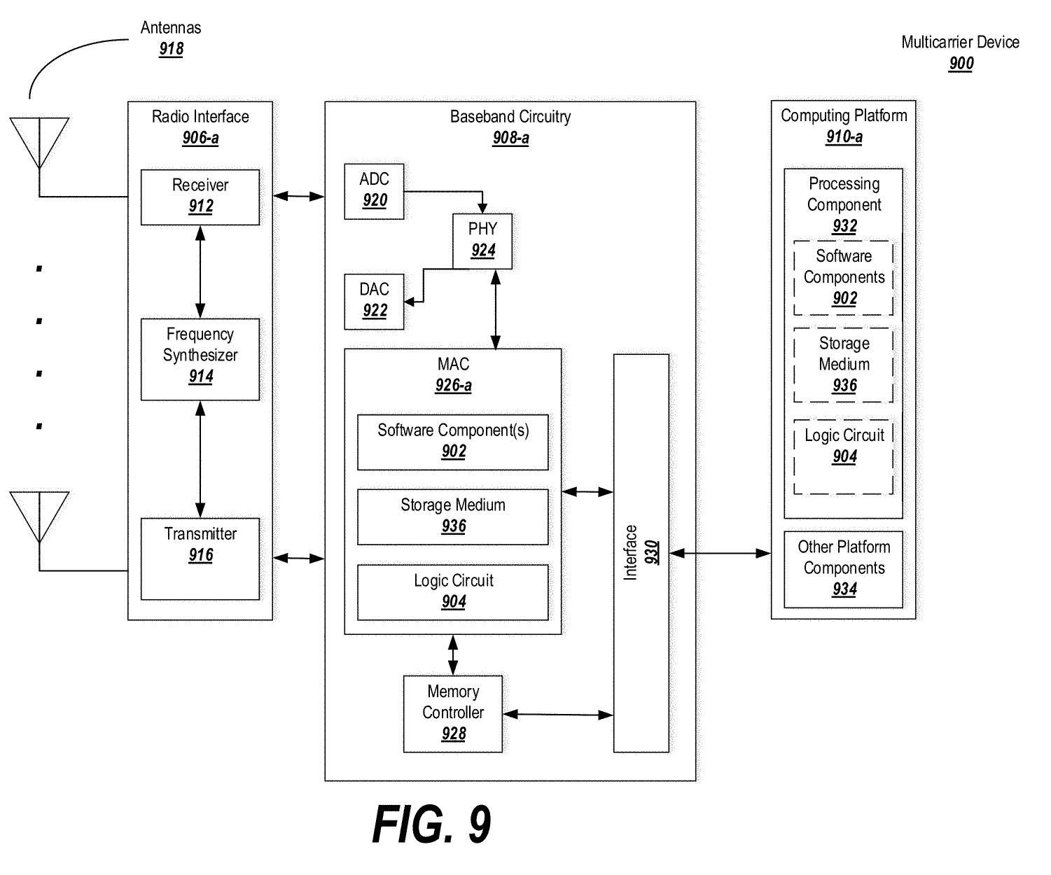

FIG. 9 illustrates an embodiment of a device 900 for use in a multicarrier OFDM system, such as the communication system 500. The device 900 may implement, for example, software components 902 as described with reference to the messaging component logic 600, the intent determination logic 700, and the group selection logic 800. The device 900 may also implement a logic circuit 904. The logic circuit 904 may include physical circuits to perform operations described for the messaging system 600. As shown in FIG. 9, device 900 may include a radio interface 906, baseband circuitry 908, and a computing platform 910, although embodiments are not limited to this configuration.

The device 900 may implement some or all of the structure and/or operations for the communication system 500 and/or logic circuit 904 in a single computing entity, such as entirely within a single device. Alternatively, the device 900 may distribute portions of the structure and/or operations for the messaging system 600 and/or logic circuit 904 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, the radio interface 906 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. The radio interface 906 may include, for example, a receiver 912, a transmitter 914 and/or a frequency synthesizer 916. The radio interface 906 may include bias controls, a crystal oscillator and/or one or more antennas 918. In another embodiment, the radio interface 906 may use external voltage-controlled oscillators (VCOs), surface acoustic wave filters, intermediate frequency (IF) filters and/or RF filters, as desired. Due to the variety of potential RF interface designs an expansive description thereof is omitted.

The baseband circuitry 908 may communicate with the radio interface 906 to process receive and/or transmit signals and may include, for example, an analog-to-digital converter 920 for down converting received signals, and a digital-to-analog converter 922 for up-converting signals for transmission. Further, the baseband circuitry 908 may include a baseband or physical layer (PHY) processing circuit 924 for PHY link layer processing of respective receive/transmit signals. The baseband circuitry 908 may include, for example, a processing circuit 926 for medium access control (MAC)/data link layer processing. The baseband circuitry 908 may include a memory controller 928 for communicating with the processing circuit 926 and/or a computing platform 910, for example, via one or more interfaces 930.

In some embodiments, the PHY processing circuit 924 may include a frame construction and/or detection module, in combination with additional circuitry such as a buffer memory, to construct and/or deconstruct communication frames, such as radio frames. Alternatively or in addition, the MAC processing circuit 926 may share processing for certain of these functions or perform these processes independent of the PHY processing circuit 924. In some embodiments, MAC and PHY processing may be integrated into a single circuit.

The computing platform 910 may provide computing functionality for the device 900. As shown, the computing platform 910 may include a processing component 932. In addition to, or alternatively of, the baseband circuitry 908, the device 900 may execute processing operations or logic for the communication system 500 and logic circuit 904 using the processing component 932. The processing component 932 (and/or the PHY 924 and/or MAC 926) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 910 may further include other platform components 934. Other platform components 934 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

The device 900 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of the device 900 described herein, may be included or omitted in various embodiments of the device 900, as suitably desired. In some embodiments, the device 900 may be configured to be compatible with protocols and frequencies associated one or more of the 3GPP LTE Specifications and/or IEEE 1402.16 Standards for WMANs, and/or other broadband wireless networks, cited herein, although the embodiments are not limited in this respect.

Embodiments of device 900 may be implemented using single input single output (SISO) architectures. However, certain implementations may include multiple antennas (e.g., antennas 918) for transmission and/or reception using adaptive antenna techniques for beamforming or spatial division multiple access (SDMA) and/or using MIMO communication techniques.

The components and features of the device 900 may be implemented using any combination of discrete circuitry, application specific integrated circuits (ASICs), logic gates and/or single chip architectures. Further, the features of the device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium 936 may include instructions that, when executed, cause a system to perform any of the computer-implemented methods described herein.

### General Notes on Terminology

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-readable medium storing instructions that, when executed by a processor, cause the processor to:
receive a report of a status of a user interaction with a platform;
look up the status of the user interaction in a status map, the status map associating the status as a triggering condition with a conversation for a helper bot;
retrieve a communication associated with the conversation, the communication associated with a communication identifier that encapsulates a context of the conversation; and
transmit the communication as part of a messaging thread between the helper bot and a user associated with the user interaction.

2. The medium of claim 1, wherein the triggering condition is a real-time event associated with the platform.

3. The medium of claim 1, wherein the triggering condition is an asynchronous event associated with the platform.

4. The medium of claim 1, further storing instructions for delaying transmission of the communication when it is determined that the user is inactive or has recently been contacted by the helper bot.

5. The medium of claim 1, further storing instructions for incorporating the communication identifier into the communication as metadata in a header of the communication.

6. The medium of claim 1, wherein the communication identifier serves as a link to a previous context of the conversation.

7. The medium of claim 1, wherein the conversation comprises a plurality of communications including a starting communication, and the communication identifier identifies an intermediate communication after the starting communication to be used as a starting point when the triggering condition is encountered.

8. A system comprising:
a network interface configured to receive a report of a status of a user interaction with a platform;
mapping logic, executable on a processor circuit, the mapping logic configured to look up the status of the user interaction in a status map, the status map associating the status as a triggering condition with a conversation for a helper bot;
communication logic executable on the processor circuit, the communication logic configured to retrieve a communication associated with the conversation, the communication associated with a communication identifier that encapsulates a context of the conversation, wherein
the network interface is further configured to transmit the communication as part of a messaging thread between the helper bot and a user associated with the user interaction.

9. The system of claim 8, wherein the triggering condition is a real-time event associated with the platform.

10. The system of claim 8, wherein the triggering condition is an asynchronous event associated with the platform.

11. The system of claim 8, wherein the network interface is further configured to delay transmission of the communication when it is determined that the user is inactive or has recently been contacted by the helper bot.

12. The system of claim 8, wherein the communication logic is further configured to incorporate the communication identifier into the communication as metadata in a header of the communication.

13. The system of claim 8, wherein the identifier serves as link to a previous context of the conversation.

14. The system of claim 8, wherein the conversation comprises a plurality of communications including a starting communication, and the communication identifier identifies an intermediate communication after the starting communication to be used as a starting point when the triggering condition is encountered.

15. A method, comprising:
receiving a report of a status of a user interaction with a platform;
looking up the status of the user interaction in a status map, the status map associating the status as a triggering condition with a conversation for a helper bot;
retrieving a communication associated with the conversation, the communication associated with a communication identifier that encapsulates a context of the conversation; and
transmitting the communication as part of a messaging thread between the helper bot and a user associated with the user interaction.

16. The method of claim 15, wherein the triggering condition is a real-time event associated with the platform.

17. The method of claim 15, wherein the triggering condition is an asynchronous event associated with the platform.

18. The method of claim 15, further storing instructions for delaying transmission of the communication when it is determined that the user is inactive or has recently been contacted by the helper bot.

19. The method of claim 15, further storing instructions for incorporating the communication identifier into the communication as metadata in a header of the communication.

20. The method of claim 15, wherein the identifier serves as link to a previous context of the conversation.
